(19) United States
(12) Patent Application Publication
(10) Pub. No.: US 2016/0264292 A1
(43) Pub. Date: Sep. 15, 2016

(54) COLLAPSIBLE SHIPPING CONTAINER

(71) Applicant: A-1 PACKAGING SOLUTIONS, INC., St. Charles, IL (US)

(72) Inventor: Kenneth F. Schoening, St. Charles, IL (US)

(21) Appl. No.: 15/068,310

(22) Filed: Mar. 11, 2016

Related U.S. Application Data
(60) Provisional application No. 62/277,338, filed on Jan. 11, 2016.
(60) Provisional application No. 62/132,760, filed on Mar. 13, 2015.

(51) Int. Cl. B65D 19/38; B65D 19/00; B65D 19/44; G06Q 10/08; G06K 7/10

(52) U.S. Cl. CPC B65D 19/385; G06Q 10/0833; G06K 7/10366; B65D 19/44; B65D 19/004; B65D 2519/0097; B65D 2519/00815; B65D 2519/00865

(57) ABSTRACT

A collapsible and stackable shipping container for shipping a product may be reused and customized for the product to be shipped. The shipping container includes a base, a plurality of support struts mounted on the base, and a top or a cover. The plurality of support struts are movable relative to the base between an upright position and a collapsed position. Each support strut may be rotatably attached to the base and may fit within feet or other support structures formed within the base. In the collapsed position, the plurality of support struts are stored on the base, such as within one or more cavities formed in the base. The shipping container may include a radio-frequency identification (RFID) tag for use in tracking the shipping container or a system of shipping containers.

### CROSS-REFERENCE TO RELATED APPLICATIONS

The present application claims priority to and the benefit of the filing date of U.S. Provisional Patent Application Ser. No. 62/277,338, filed Jan. 11, 2016, and U.S. Provisional Patent Application Ser. No. 62/132,760, filed Mar. 13, 2015, the entire disclosures of which are hereby expressly incorporated by reference herein.

### RELATED TECHNOLOGY

The present application relates to a shipping pallet or container that may be reused, stacked with similar pallets or containers, customized according to load/product, collapsed for non-use, and tracked by radio-frequency identification (RFID) technology.

### BACKGROUND

Packaging and shipping practices face significant challenges in the form of sustainability, assembly time, material costs, and product protection. Typical packaging methods are not cost effective because it is common to make and assemble new packaging for each product shipment. A typical shipping container is made up of a wooden pallet for a base, cardboard or other paper-based walls, plastic wrap around the product, and another wooden pallet or cardboard layer for a cover. While typical packaging assemblies are simply constructed and made of inexpensive materials, the cumulative time to build and assemble each package for every shipment can place a large cost on the shipper in terms of labor and results in wasted or non-reusable materials.

In particular, typical packaging processes are not sustainable because the wooden pallets are often discarded after just one shipment, increasing the overall cost of shipping and resulting in a tremendous amount of waste, which must be disposed of at a cost to the customer. Additionally, there is no incentive to recycle or reuse the pallets because they are cheaply made and easily deform during transport. Moreover, cheaply made packaging is rarely customized for the product being shipped and may not adequately protect or support the product during shipment.

### SUMMARY

A collapsible and reusable shipping container, also referred to as a pallet, described herein overcomes these challenges because the shipping container may be reused, stacked, customized according to load/product, collapsed for non-use, and tracked by radio-frequency identification (RFID) technology. In particular, the collapsible shipping container described herein includes a base, a top, and four or more collapsible support struts. When the shipping container is in an upright configuration, the base supports a product to be shipped, the struts provide supportive structure to the container and are supported by the base, and the top covers the struts, holds the struts in place at the top of the unit, and enables different ones of the shipping containers to be stacked on top of one another. The shipping container may also be wrapped in plastic stretch wrap for added protection during use. To store the shipping container when not being used, the struts may be folded or collapsed down and may be stored on or adjacent to the base, such as within a cavity formed into the base. The base may be customized to ship a particular product so that the product being shipped securely sits within the base during shipping.

In some cases, the base may include a plurality of feet for working with a fork-lift, a platform customized for shipping a specific product, and, if desired, storage channels for storing the struts. In some instances, some or all of the plurality of feet extend from a bottom surface of the base and may form impressions on the top surface of the base. Each of the impressions in the four corners of the base may house a support structure or connector which secures the struts to the base. The support structure may be a locking assembly and the impressions created by the feet may facilitate stacking of multiple bases because, for example, the feet of a first base fit within the impressions made by the feet of a second base.

The platform of the base may provide stability elements that are customized according to the product being shipped. In one example, the stability features are rounded protrusions that are formed on a platform surface of the base to stabilize a product, such as rolls of fabric, paint cans, etc. The round protrusions limit the movement of the rolls of fabric or cans, while the shipping container is being transported. In another example, the platform may provide a stability element in the form of a square indentation to support and secure a product with a square shape. A customized base or base insert may be made to protect the product better than generic packaging used today and this customized base or insert may be reused many times to ship the same or similar products.

In some cases, a plurality of removable inserts may be used within a particular shipping container, so that the struts provide or define side walls for a plurality of layers of products, with each layer of product being supported or defined by a new insert. In some cases, the inserts may have cut out portions or protrusions that interact with the struts of the shipping container to cause the inserts to be securely retained between the struts of the shipping container at the corners of the shipping container.

The top or cover of the shipping container may include receiving features on a bottom surface to attach to, to interact with, or to rest on the support struts, and the top or cover may include a plurality of stacking elements, also referred to as barrier members, on a top surface thereof. The stacking elements may be pressure-formed wall barriers that define spaces large enough to receive the feet of a second base. As such, the stacking elements of the top or cover of the shipping container may interact with the base of another shipping container as provide secure stacking of multiple shipping containers on top of one another during shipping. This feature enables more shipping containers and thus more product being shipped to fit in a given truck, for example, and assist in limiting the movement of the shipping containers relative to one another when stacked. The stackable features of the shipping containers allow more shipping containers to fit within a shipment, and simultaneously minimize damage to the shipping container and, of course, to the product being shipped. The features and the durable materials described herein also extend the life of a shipping container.

The struts may be rotatably connected to the base so that the struts may rotate from an upright, in-use position to a collapsed, storage position in which the shipping container may be easily stored . Each strut has a bottom end and a top end, the bottom end of each strut may be rotatably and if desired, removably attached to one of the four corners of the base. When the shipping container is in the upright position, each strut is erect, meaning that the strut is perpendicular to the base and the top attaches to or rests on the top ends of the struts. When the shipping container is not in use and is in the collapsed position, each strut may be stored within a storage channel formed in the base or may be stored in a position along an upper edge of the base. Adjacent struts may collapse or fold down onto or in the base and may interleave with each other in the storage position. The shipping container with the collapsible struts may be easily assembled and disassembled by rotating or moving the struts from the collapsed position to the upright position and then locking the strut into place. The collapsible nature of the shipping container significantly reduces assembly time and material costs incurred by the shipper and decreases the amount of space needed to store an unused shipping container. Each shipping container may also include all of the parts needed for assembly (plastic wrap may be excluded) and therefore does not require additional hardware or construction materials to assemble or disassemble.

In some cases, each support strut may rotate or move between the collapsed and noncollapsed (e.g., the storage and upright or in use) positions by way of a locking assembly, connector, and/or a support structure. Each locking assembly, also referred to a connector assembly, may be secured to the base and may be attached to one of the struts. In one example, a locking assembly may include a support receiver, a lateral support, and a pin. The locking assembly may attach to a bottom portion of the strut so that once the strut is connected to the locking assembly, the strut can easily move from the collapsed position to the upright position. For example, in the upright position, the strut sits within the strut receiver and its lateral movement is limited by the walls of the strut receiver. To collapse the strut, an operator need only lift the strut out of the receiver, rotate the strut about the pin so that the strut is parallel to the base, and store the strut in or on the base, such as within one of as set of storage channels of the base. The struts, support structures, locking assemblies, and storage channels facilitate assembly and disassembly of the shipping container.

In contrast to many shipping containers that use standard pallets associated with current packaging practices, the shipping container described herein may be prefabricated and may be reused. Further, the struts may be adjusted to accommodate multiple products of varying sizes. In one example, the height of a strut may be adjusted, allowing a shipper to change the height of the shipping container according to the height of the product being shipped. The adjustable strut may fold or collapse to a smaller, folded strut for storage.

Once a product or set of products is secured to the shipping container, a protective feature, such as a stretch wrap or corrugated sleeves, may be applied around the shipping container for additional support and protection. For example, a plastic stretch wrap may provide additional support to the struts as well as protection to the product from weather and debris. The plastic stretch wrap may be clear or transparent, may be one of a variety of colors to aid in identifying the product being shipped, or alternatively, may be an opaque color, such as black, to hide the product from visibility.

Each shipping container may include a radio-frequency identification (RFID) tag embedded (or applied) in the base or other portion thereof, and the RFID tag may be used to track the shipping container, the contents of the shipping container, or both. In one case, the RFID tag may identify each shipping container with an unique number, also referred to as a tag identifier, to enable an owner to keep track of his or her inventory of shipping containers. For example, the owner may keep track of a shipping container shipped to a customer by scanning an RFID tag attached to the shipping container when the shipping container is sent out to the customer, and again when the shipping container is returned by the customer. For each scan, the owner may keep records related to the particular shipping container, including type of product for which the shipping container is customized, the identity of the customer receiving or returning the shipping container, the state or operability status of the shipping container, etc. A tracking system using RFID technology facilitates inventory organization so that an owner may better track his or her inventory and therefore protect his or her investment.

### BRIEF DESCRIPTION OF THE DRAWINGS

FIG. 1 illustrates a perspective view of a collapsible shipping container when configured to be in a upright position.

FIG. 2 illustrates a perspective view of a base of the shipping container of FIG. 1 wherein the support struts are in an upright position.

FIG. 3A illustrates a perspective view of the base of FIG. 2 wherein the support struts are folded in a collapsed position.

FIG. 3B illustrates an example of a base in a collapsed position.

FIG. 3C illustrates an exploded, perspective view of an example of a base and a removable insert.

FIG. 3D illustrates an exploded, perspective view of an example of the base in FIG. 3C and an example of a removable insert.

FIG. 3E illustrates a perspective view of the base in FIGS. 3C-3D and an example of a removable insert secured to the base.

FIG. 4 illustrates a perspective view of a top of the shipping container of FIG. 1.

FIG. 5A illustrates a perspective, partial view of a support strut rotatably connected to a locking attached to a base.

FIGS. 5B-5D illustrate alternative examples of a locking assembly that may be used in the shipping containers of FIGS. 1-2.

FIGS. 6A and 6B illustrate perspective views of examples of an adjustable support strut.

FIG. 7 illustrates a perspective view of the shipping container of FIG. 1 assembled in the upright position, supporting products to be shipped, and wrapped in a protective wrap.

FIG. 8 illustrates a perspective view of the assembled shipping container of FIG. 1 stacked directly on top of a second, identical shipping container.

FIG. 9 illustrates a perspective view of the shipping container of FIG. 1 stacked in an off-set position on top of four identical shipping containers.

FIG. 10 illustrates a perspective view of an example of a top covering a base of a collapsible shipping container in the collapsed position.

FIG. 11 illustrates a tracking system used to scan and track collapsible shipping containers using radio-frequency identification (RFID) tags.

FIG. 12 illustrates another example of a collapsible shipping container in an in-use configuration.

FIG. 13 illustrates the collapsible shipping container of FIG. 12 in a collapsed or storage configuration.

FIG. 14 depicts a perspective view of a base of the shipping container of FIG. 12 in the collapsed configuration.

FIG. 15 depicts a top view of a metal support structure that forms a portion of the base of FIG. 14.

FIG. 16 depicts a partially cut-away view of one of the corners of the base of the shipping container of FIG. 12 with a strut in the collapsed position.

FIG. 17 depicts a partially cut-away view of one of the corners of the base of the shipping container of FIG. 12 with a strut in the extended position.

FIG. 18 depicts a perspective view of one of the struts of the shipping container of FIG. 12.

FIG. 19 depicts the shipping container of FIG. 12 in an in-use or expanded configuration with a series of paint cans disposed on a first support insert.

FIG. 20 depicts the shipping container of FIG. 12 in an in-use or expanded configuration with a series of paint cans disposed on first and second support inserts that create two layers of product supports within the shipping container.

### DETAILED DESCRIPTION

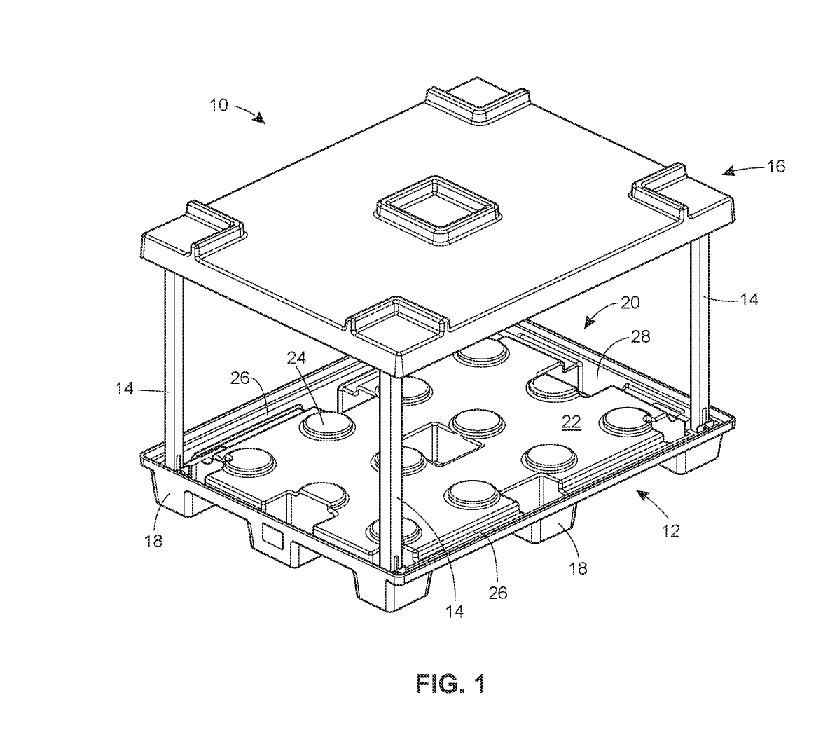

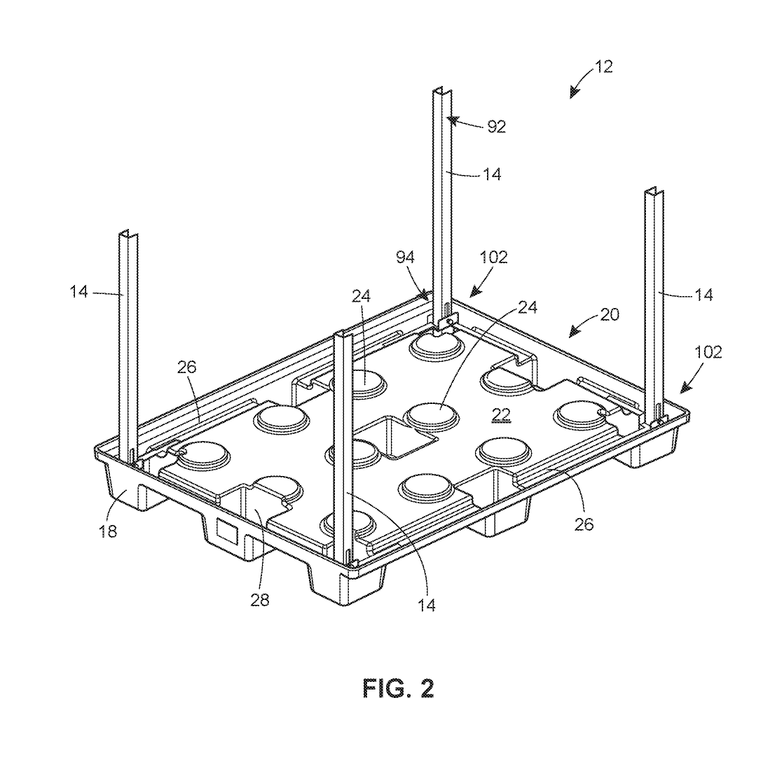

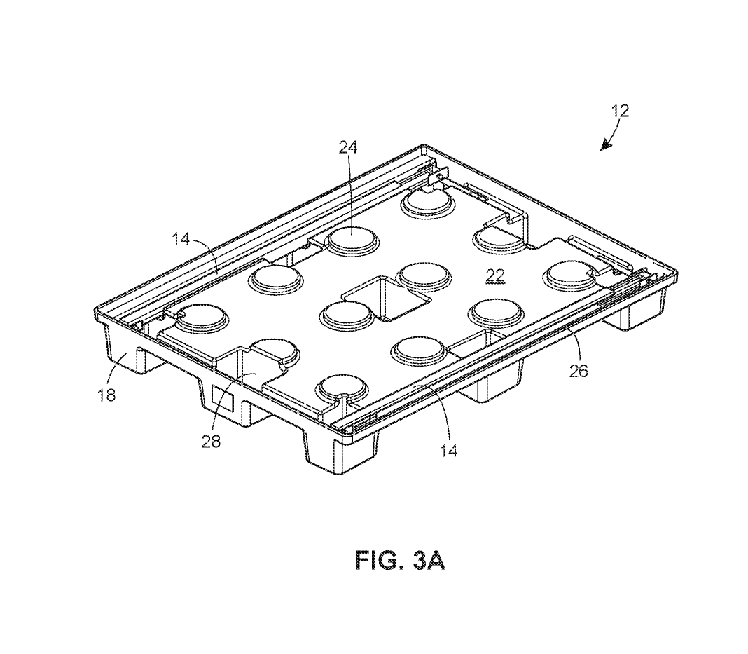

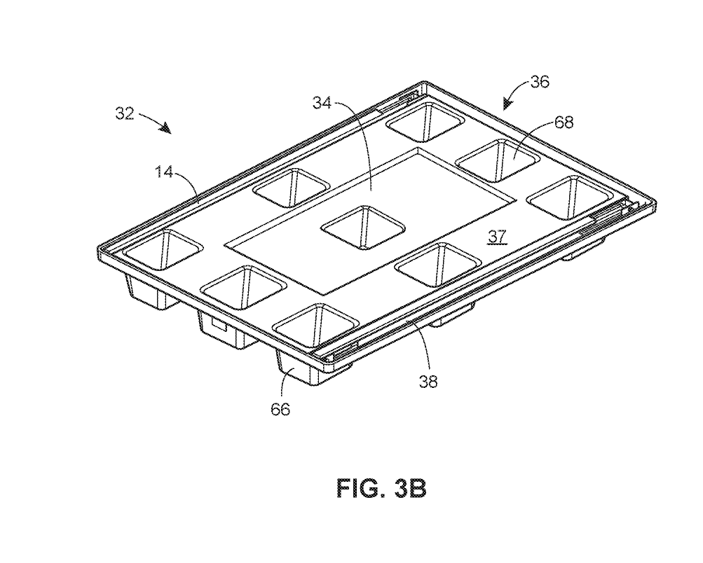

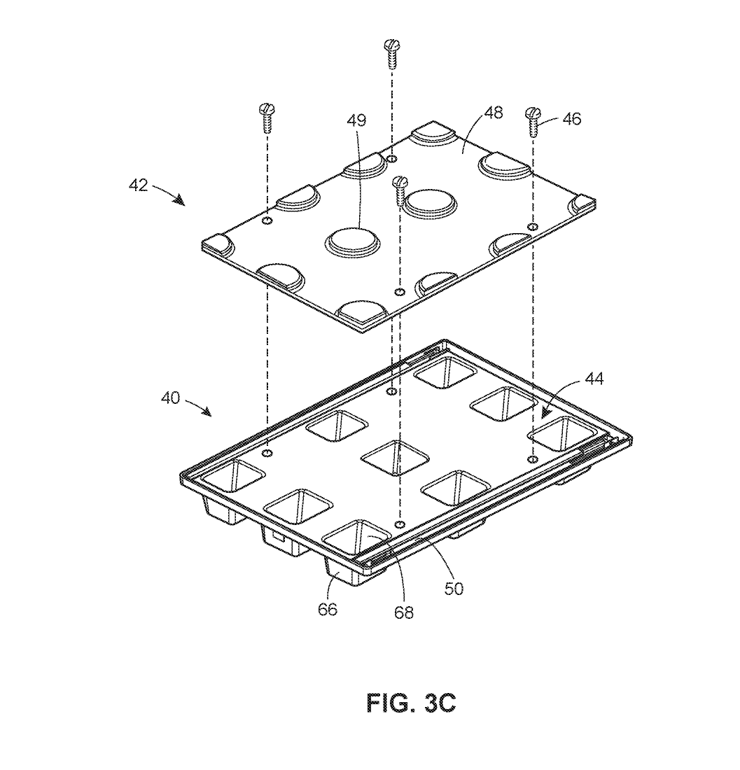

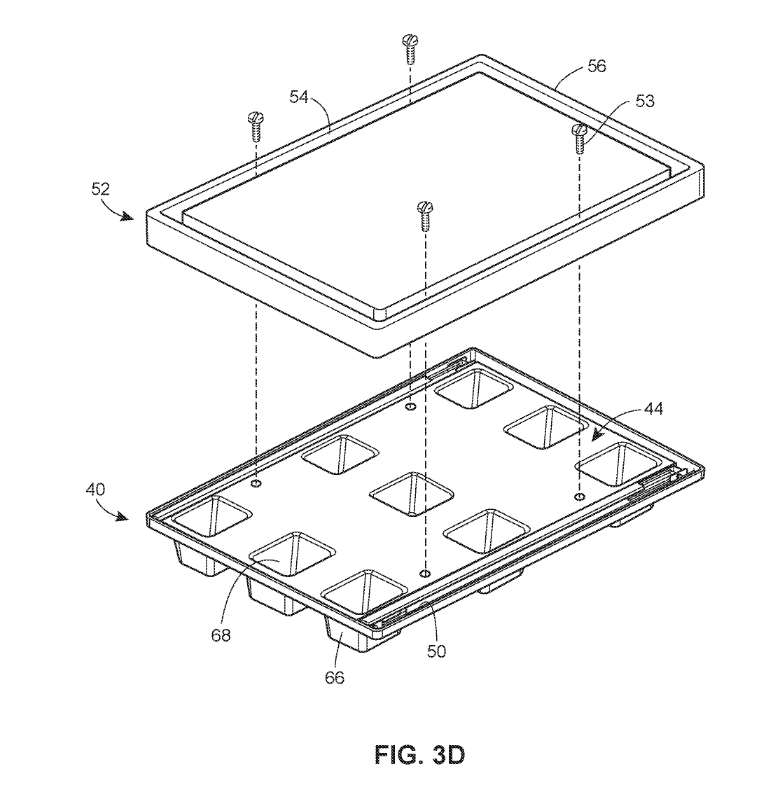

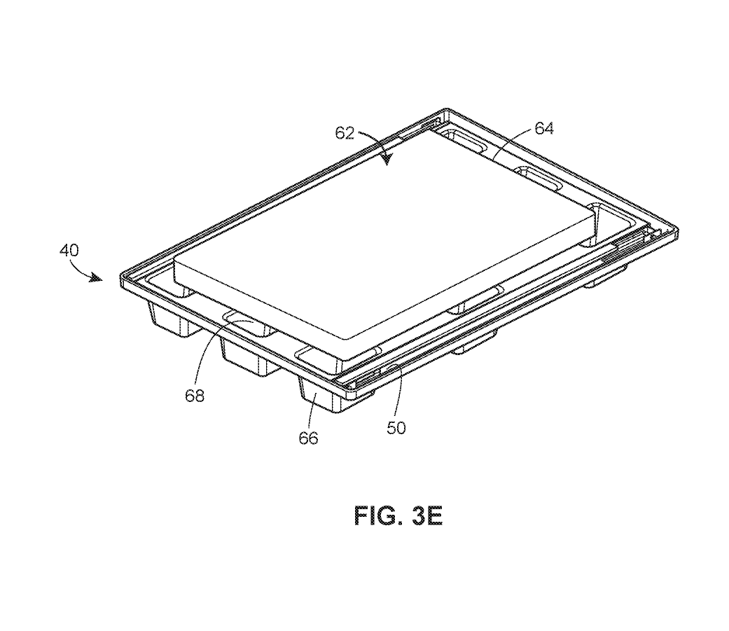

FIGS. 1-3E illustrate a variety of configurations of a collapsible shipping container 10, also referred to a pallet, for shipping a particular product, including an upright configuration for shipping (FIG. 1-2), a collapsed configuration for storage (FIGS. 3A-3B), and a partially-assembled variation. The configurations of the shipping container 10 of FIGS. 1-3E illustrate how a customized shipping container may be easily assembled from a collapsed position to an upright position. In particular, the collapsible shipping container 10 in FIG. 1 includes a base portion or base 12 for retaining and supporting a load, a plurality of support struts 14 in the upright position and anchored to the base 12, and a top portion or cover 16 that covers a product being shipped and that attaches to or interacts with the upper ends of the support struts 14. The product may be stacked on the base 12 when the struts 14 are in the upright position or when the struts 14 of the shipping container 10 are in the collapsed position. For example, when the shipping container 10 is in the collapsed configuration as illustrated in FIGS. 3A-3E, a product may be secured to the base 12 and the struts 14 may then be lifted from the collapsed position to the upright position, as illustrated in FIG. 2, and then covered by the top 16, as illustrated in FIG. 1. The shipping container 10 disassembles or collapses just as easily and, in particular, can be collapsed by removing the top 16 from the struts 14 and folding and storing the struts 14 within or on the base 12. The top 16 and base 12 are preferably made of a durable plastic, such as polyethylene, that may be formed by injection molding, thermoforming, or compression molding, but may instead be formed of any other suitable and durable material including metal, fiberglass, or other similar materials, or any combination of these materials.

Many of the advantages of the collapsible shipping container 10 originate in the construction and configuration of the base 12. The base 12 supports the load of the product being shipped, provides customized stability elements to secure the product being shipped, and provides storage for the support struts 14 when the shipping container 10 is not being used. As illustrated in FIGS. 1-3A, the base 12 may be supported by a plurality of hollow feet 18 that extend from a bottom surface or bottom side of the base 12. In this example, a top side 20 of the base 12 provides a platform 22 with a plurality of stability elements 24, peripheral storage channels 26 or cavities, and a plurality of impressions 28 formed by the hollow feet 18.

As best illustrated in FIGS. 2-3A, the shipping container 10 may be customized to better hold and support a product in a number of manners. For example, the base 12 may provide a plurality of stability elements 24 disposed on the top surface 20 of the platform 22 or embedded within the platform 22. The stability elements 24 may be customized according to the shape, size, and number of products being shipped, and may take a variety of forms, such as indentations, dimples, projections, or protrusions to keep the product or products being shipped from sliding, shifting, or tipping during shipment. For example, the stability elements 24 in FIGS. 1-3A include a plurality of round protrusions spatially arranged on the platform 22. The round protrusions, in particular, are adapted to facilitate stacking of rolls of fabric or other material while simultaneously preventing the rolls of fabric or other material from rolling or shifting while the shipping container 10 is in transit. In another example illustrated in FIG. 3B, a base 32 may provide a single stability element 34 formed on a top side 36 of the base 32 for shipping a large product or products. In this case, the stability element 34 creates a rectangular impression within in a platform 37 of the base 32. The product may securely sit within the stability element 34 such that the edges of the rectangular indentation 34 effectively provide barriers to the four sides of the product. This example base 32 also provides cavities or storage channels 38 that do not overlap with the feet impressions 68 of the platform 37. FIGS. 1-3B illustrate the platform 22, 37 and stability elements 24, 34 integrally formed within the base 12, 32. In other examples, the platform and stability elements may be made up of one or more removable parts, for example, an insert that securely attaches to the base, rests on the base, is added to the top surface or platform of the base, etc.

FIGS. 3C-3E illustrate an embodiment of a base 40 adapted to receive a removable insert 42, 52, 62. The insert 42, as illustrated in FIG. 3C, may be a separate structure that attaches to a top side 44 of the base 40 by a plurality of fasteners 46, which may be screws, rivets, snap-on fasteners or friction fitted by the struts, etc. The insert 42 provides a support surface 48 that may have one or more stability elements 49, such as indentations, projections, dimples, etc., that conform to the dimensions of a particular product or products being shipped. In the illustrated example, the insert 42 provides a plurality of stability elements 49 in the form of round protrusions. The insert 42 is secured to the top side 44 of the base 40 in at least two locations by the fasteners 46 without overlapping a plurality of peripheral storage channels 50 which hold struts disposed on the base 40. The fasteners 46 may be semi-permanent, such as bolts, nails, screws, or other similar hardware which allow a user to remove an insert 42 and replace it with another insert 42. Alternatively, the insert 42 may be permanently attached to the base 40 by adhesive, friction fitted or other hardware. The stability elements 49 of the insert 42 are similar to the stability elements 24 illustrated in FIGS. 1-3A. FIG. 3D illustrates another embodiment of a removable insert 52 that secures to the top side 44 of the base 40 by fasteners 53. The insert 52 in this case includes a rectangular channel 54 that is inset a predetermined distance from an outer perimeter 56 of the insert 52. The dimensions and location of the channel 54 may be determined according to the specifications of a product being shipped. In another embodiment, a plurality of bores may replace the rectangular channel 54 to hold a plurality of corresponding legs of a product being shipped. As illustrated in FIGS. 3C and 3D, the inserts 42, 52 may be attached to a standard base 40. The standard base 40 may not be customized, but rather may receive and secure any removable insert that is specifically shaped for shipping a particular product. The standard base 40 may be used for shipping any product by simply removing and replacing the insert 42, 52 with another insert. While not illustrated, the insert 42, 52 may be adapted to attach to the bases 12, 32 of the shipping containers illustrated in FIGS. 1-3B by a plurality of fasteners.

The inserts 42, 52 may be molded according to the dimensions of the product being shipped and is preferably made of a durable plastic, such as polyethylene, that may be formed by injection molding or compression molding. Alternatively, the inserts 42, 52 may be formed of any other suitable material including metal or fiberglass. Additionally, the inserts 42, 52 may include an additive, such as a rubber coating or an abrasive coating, that is disposed on the top surface of the insert and/or between the top surface 44 of the base 40 and the bottom surface of the insert 42, 52, to increase the frictional properties of the interface between the insert 42, 52 and the products being shipped and/or between the insert 42, 52 and the base 40. In yet another embodiment, an insert may be a pliable material such as a moldable foam or a pliable gel. In FIG. 3E, for example, an insert 62 may include a rectangular block 64 of pliable material that molds to the shape of a product being shipped when the product contacts the insert 62. The pliable material has an original shape, such as the rectangular-shaped block 64, that is configured to change shape under the weight of the product and mold to the particular shape of the product. The pliable material, which may be a memory foam material, holds the shape of the product, providing support and limiting movement of the product relative to the base 40 during shipment. Once the product is removed from the insert 62, the pliable material shifts back to the original rectangular-shaped block 64.

The shipping container 10 of FIGS. 1-3E is configured to efficiently collapse and provide at least one storage cavity for the struts 14 when the shipping container 10 is not in use. The collapsed configuration and storage features of the shipping container 10 reduce shipping costs and save space for storing unused shipping containers 10. As best illustrated in FIG. 1 in which the support struts 14 are in the upright position, the top surface 20 of the base 12 includes a storage channels or channels 26, also referred to as a cavity or cavities, that form long grooves around two or more of the four sides of the platform 22. The channels 26 provide enough space within the base 12 to store the support struts 14 so that the support struts 14 lay even with or below the top surface of the platform 22 of the base 12. In FIGS. 3A-3E, the base 12, 32, 40 of each embodiment is adapted to receive and store the support struts 14 in two of the four storage channels 26, 38, 50. However, each storage channel 26 of the base 12 may hold at least one support strut 14. The support struts 14 in FIG. 3A are U-shaped bars that overlap when two struts 14 are stored in the same storage channel 26. In another example, the support struts 14 may be reduced in size so that two struts 14 can fit into one of the channels 26 without overlapping. In yet another example of a shipping container 10, the top 16, rather than the base 12, may provide at least one cavity to store the support struts 14.

The hollow feet 18 illustrated in FIGS. 1-3A elevate and support the base 12, facilitate conveyance of the shipping container 10 via a forklift, and enable stacking. The feet 18 are spaced apart a predetermined distance so that a forklift or manual hand truck may approach and lift the base 12 from any one of the four sides of the shipping container 10. In other words, the shipping container 10 may be configured as a “four-way pallet.” As best illustrated in FIG. 2, the feet 18 provide impressions 28 formed in the top surface 20 of the base 12. The impressions 28 formed by feet 18 located in the corners of the base 12 carry the support struts 14. Additionally, the impressions 28 facilitate stacking and may be used for storing hardware parts, instructions related to the product, sales receipts, and other materials related to the shipment or the shipping container 10 assembly.

The feet 18 of the shipping container 10, and therefore the impressions 28 formed by the feet 18, are configured so that one shipping container 10 may stack on top of another shipping container 10, or more specifically, so that one base 12 may stack on top of another base 12. Even while the support struts 14 are stored in the storage channels 26 as shown in FIG. 3A, one base 12 may be stacked on top of another base 12 for easy shipment and storage of the bases 12. The feet 18 may be sloping or pyramidal in shape, or in other words, the feet 18 may taper inward as they extend outwardly from the bottom surface of the base 12. In the illustrated example of FIGS. 1-3A, the storage channels 26 overlap with the feet impressions 28 formed in the perimeter of the base 12. In FIGS. 3B-3D the base 32, 40 includes a plurality of hollow feet 66 that are spatially arranged closer to a center of the base 32, 40 than the feet 18 of the shipping container 10 illustrated in FIGS. 1-3A. By positioning the feet 66 closer to the center of the base 32, 40, the storage channels 38, 50 do not overlap with a plurality of impressions 68 made by the feet 66. Unlike the top surface 20 of the base 12 illustrated in FIGS. 1-3A, the base 32, 40 in FIGS. 3B-3D may provide unobstructed impressions 68 so that the feet 66 of one base 32, 40 may stack more closely within the impressions 68 of a second base 32, 40. Thus, when the struts 14 are within the storage channels 38, 50, the feet 66 of one base 32, 40 may fit in the impressions 68 of another base 32, 40, unobstructed by the stored support struts 14. In the collapsed position, the base 32, 40 of one shipping container 10 may stack on top of the base 32, 40 of another shipping container 10. Similarly, the base 12 of the pallet of FIG. 3A is stackable with other similarly-arranged bases 12.

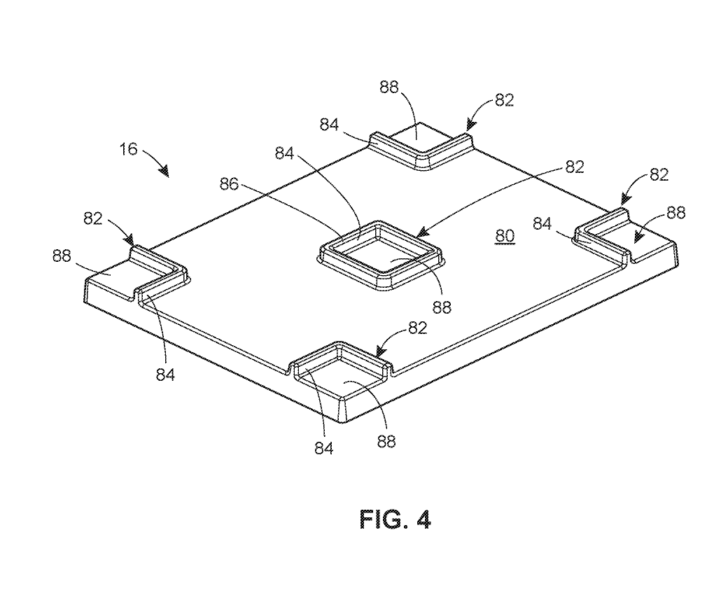

Referring now to FIG. 4, the top 16 completes the assembly of the shipping container 10. The top 16 of the shipping container 10 includes a first or bottom surface, a second or top surface 80, and a plurality of stackable elements 82, also referred to as barrier members. The bottom surface includes a plurality of engaging elements that receive the plurality of support struts 14 when the struts 14 are erect. The stackable elements 82 of the top surface 80 include a plurality of barrier walls 84 that extend vertically from the otherwise flat top surface 80. In the illustrated example, the top surface 80 of the top 16 provides four stackable elements 82 located in the corners of the top 16 and a central stackable element 86 having four barrier walls 84. The corner stackable elements 82 have two barrier walls 84 which form a right angle pointed inwardly towards a center of the top 16. The stackable elements 82, as described further below, are configured to receive the feet 18 of the base 12 of the shipping container 10 to enable stacking on the top 16. In particular, the barrier walls 84 limit rotational and lateral movement of the hollow feet 18 of the base 12 when the feet 18 of a base 12 are disposed in a space 88 defined by the barrier walls 84. The stackable elements 82 may be formed by pressure-forming or molding. While not included in the drawings, the top 16 may have one or more stability elements 24 formed on the bottom surface to securely hold the product between the top 16 and base 12 of the shipping container 10.

The collapsible shipping container 10 thus includes a plurality of support struts 14 capable of rotatably extending up to configure the shipping container 10 in an in-use configuration, as shown in FIGS. 1 and 2, and collapsing down to configure the shipping container 10 in a storage configuration, as shown in FIGS. 3A-3E,which enables a user to store and transport the shipping container 10 in a compact manner when the shipping container is not is use. As generally illustrated in FIG. 2, the support struts 14 include a top end 92 which attaches or interacts with the top 16, and a bottom end 94 which is rotatably secured to the base 12 via a support structure 102, such as a locking assembly, which is secured to, for example, the base 12. Once the struts 14 are extended up in the upright position, the top pallet 16 may be snapped onto (e.g., may slide onto or otherwise be received onto) the top ends 92 of the struts 14. When the shipping container 10 is not in use, as illustrated in FIGS. 3A-3E, the top 16 is removed and the struts 14 are stored within the storage channels 26, 38, 50. The top 16 may then be stored on top of the base 12 in a compact manner.

While the support struts 14 illustrated in FIG. 1 are U-shaped bars, the struts 14 may be adjusted and customized according to the requirements for shipping a particular product. Each strut 14 may be, for example, a hollow square bar, a U-channel bar, a solid square bar, a hollow cylinder, a solid cylinder, or any other desired shape and configuration. The support struts 14 may be formed from plastic, composite, fiberglass, steel, aluminum, or any other suitable material that is preferably lightweight, but that supports a desired amount of weight. The U-shaped bars in FIGS. 1-3E allow the struts 14 to overlap when in the collapsed position, or in other words, are configured so that one strut 14 may receive a second strut 14 without requiring a larger storage channel 26, 38, 50. A few examples of adjustable struts 14 are more explicitly described below.

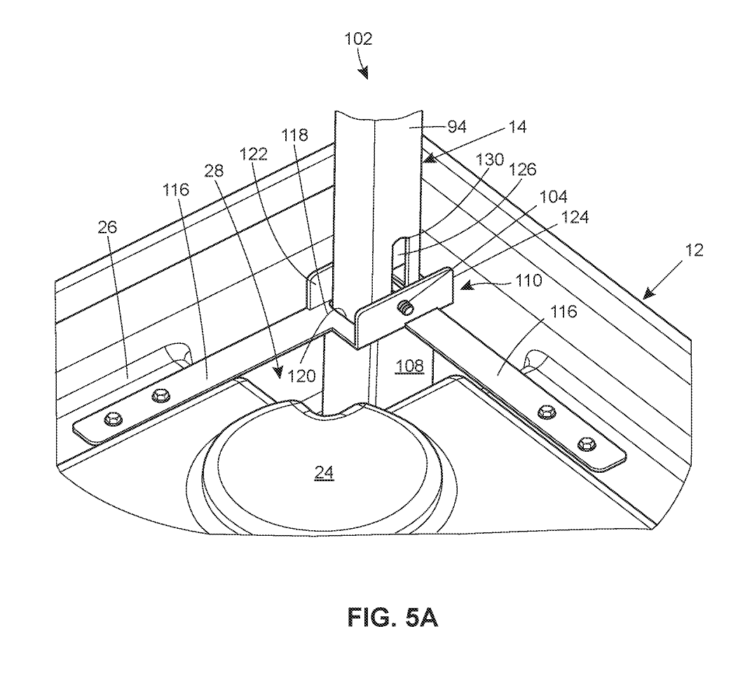

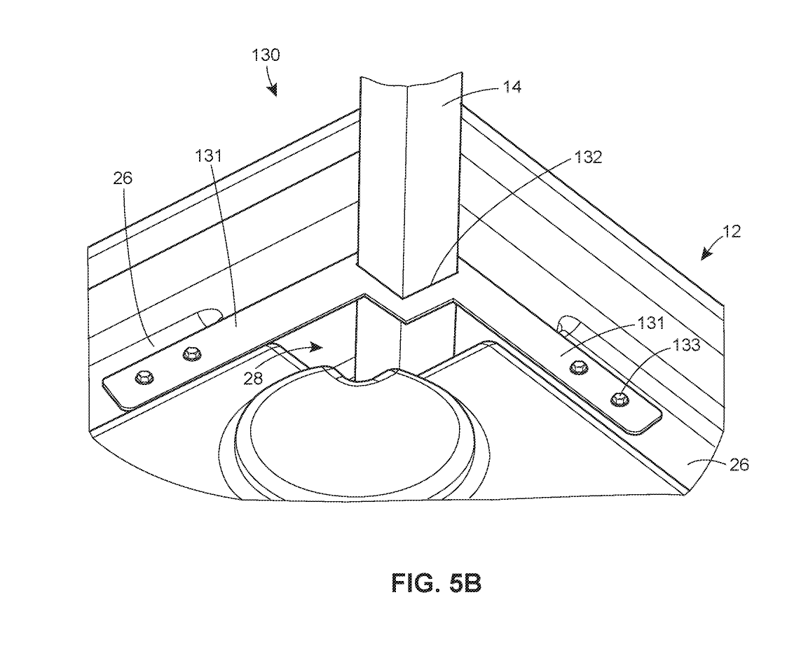

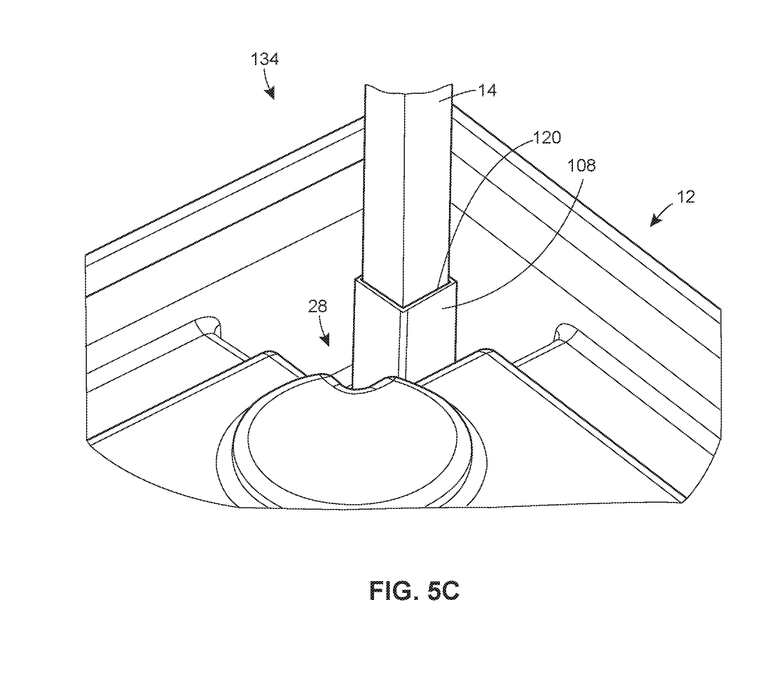

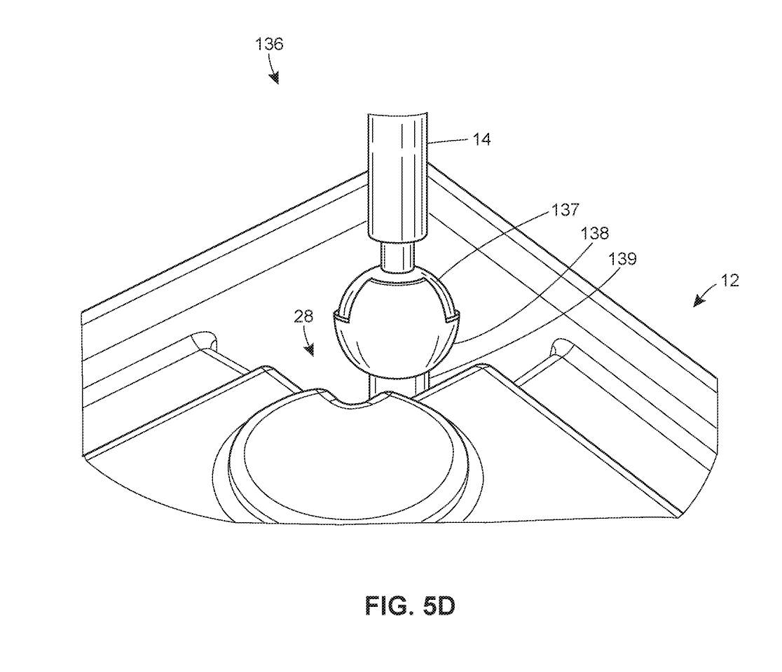

FIGS. 5A-5D illustrate different embodiments of a support structure 102, also referred to as a connector, configured to secure the strut 14 in the upright position relative to the base 12. The support structure 102 in FIG. 5A is a locking assembly, also referred to a connector assembly, that is configured to rotatably connect to the strut 14 to the base 12, providing the convenient and time-saving collapsible feature of the shipping container 10. The locking assembly 102 operatively couples the strut 14 to the base 12 so that the shipping container 10 may be configured to the upright position for shipping or to the collapsed position for storage. Once the struts 14 are attached to the base 12 by way of the locking assembly 102, the struts 14 do not need to be removed from the locking assembly 102 unless the struts 14 need to be replaced. Each strut 14 and corresponding locking assembly 102 is located within the impressions 28 located in the corners of the base 12. In the example of FIG. 5A, the locking assembly 102 includes a locking pin 104, a strut receiver 108 mounted to the base 12, and a lateral support 110 attached to the base 12. The receiver 108 is large enough to receive the bottom end 94 of the strut 14 and is preferably rounded at the bottom side thereof to bear a heavy load without breaking through the base 12. The lateral support 110 illustrated in FIG. 5A is a corner bracket having two arms 116 mounted to the storage channels 26 (or otherwise to the base 12) on either side of the corner impression 28. The arms 116 meet in the corner of the base 12 and create a corner portion 118 having an opening 120 and first and second guide flanges 122, 124. The opening 120 is sized to receive the bottom 94 of the strut 14. The flanges 122, 124 extend vertically upward along two parallel sides of the opening 120, which serve to guide the struts 14 when the struts 14 shift between the collapsed position (as illustrated in FIGS. 3A-3E, for example) and the upright position (as illustrated in FIGS. 1 and 2, for example). Each flange 122, 124 includes an aperture that is axially aligned to the aperture of the opposing flange and is adapted to receive the pin 104.

The support strut 14 depicted in FIG. 5A may be configured to rotatably connect with the locking assembly 102. In particular, the bottom end 94 of the strut 14 includes an oblong channel 126 formed in two parallel sides of the strut 14. The strut 14 is positioned so that the oblong channels 126 face the flanges 122, 124 of the lateral support 110. To rotatably connect the strut 14 to the locking assembly 102, the bottom portion 94 of the strut 14 slides through the opening 120 of the corner portion 118 of the lateral support 110 and into an opening of the strut receiver 108. The pin 104 may then slide through a hole in the first flange 122, through the pair of oblong channels 126 of the strut 14, and through a second hole in the second flange 124. When the pin 104 engages the strut 14 and the lateral support 110, the pin 104 effectively limits the vertical movement of the strut 14 to the distance of the oblong channel 126. For example, the pin 104 may abut against a top end 130 of the oblong channel 126 when the strut 14 is in the upright position. The pin 104 may abut against a bottom end of the channel 126, as shown in FIG. 5A, when the strut 14 is lifted for collapsing the shipping container. At the point where the pin 104 abuts the bottom end of the channel 126, the strut 14 may rotate about the pin 104 toward the storage channel 26 until the strut 14 is parallel to the top surface of the base 12. The strut 14 may then be placed within or may naturally fit within the storage channel 26, resting on the arms 116 of the lateral support 110.

The collapsible feature is enabled once the strut 14 is rotatably connected to the base 12 via the locking assembly 102 as illustrated in FIG. 5A. After each strut 14 is attached to the locking assembly 102, configuration of the shipping container 10 into the upright or shipping position simply includes lifting each strut 14 to rotate the strut 14 about the pin 104 until the strut 14 is in the full upright position, sliding the strut 14 down so that the bottom end of the strut 14 slides into the strut receiver 108 at which time the pin 104 slides within the channel 126 until the pin 104 hits or contacts the top end of the channel 126 or the bottom of the strut hits or contacts the bottom surface of the strut receiver 108. The configuration of the shipping container 10 to the storage position includes lifting each strut 14 so that the pin 104 slides down within or towards the bottom end of the channel 126 until the bottom end 94 of the strut 14 exits the strut receiver 108, and rotating the strut 14 about the pin 104 towards the storage channel 26 until each strut 14 rests or comes into contact with a respective one of the storage channels 26. Thus, to assemble the shipping container 10 into the upright position, the strut 14 must be lifted from the storage channel 26 and rotated about the pin 104 until the strut 14 is perpendicular to the base 12 and in the upright position. The strut 14 is then lowered into the strut receiver 108 where the strut receiver 108 effectively holds the strut 14 into place. To store the struts 14 within the storage channels 26, the struts 14 must be lifted from the strut receivers 108 and rotated about the pins 104 until the struts 14 are parallel to the base 12 and placed in the storage channels 26.

FIG. 5B illustrates an example of a support structure secured to the base 12 at a corner impression 28, and includes a corner bracket 130 having two arms 131, an aperture 132, and a plurality of fasteners 133. Each of the arms 131 may be attached to at least one storage channel 26 of the base 12 by one or more fasteners 133. The aperture 132 is located within the space of the corner impression 28 and is sized to receive a strut 14. FIG. 5C is yet another example of a support structure 134 simply including a strut receiver 108 (similar to the strut receiver of FIG. 5A) including an opening 120 sized to receive and hold the strut 14 in place. The support structures 130, 134 limit lateral and rotational movement of the strut 14 while the strut 14 is in the upright position. To assemble a strut 14 in the upright position, each strut 14 may be removed from the storage channel 26 and placed in the aperture 132 of the corner bracket 130 or the opening 120 of the strut receiver 108. To configure the shipping container 10 into the storage position, in which the struts 14 are placed into the storage channels 26, each strut 14 may be removed from the corner bracket 130 or strut receiver 134 by lifting the strut 14 vertically out of the support structure 130, 134 and may then be placed into the storage channel 26. While not shown, the struts 14 may be attached to the base 12 in some manner, such as by a string, a cord, such as an elastic cord, and which may, in some cases, retract into the strut 14 and/or the strut receiver 108 or the impression 28. The string or cord may operate to connect the strut 14 to the base 12 but allow the strut 14 to be moved vertically relative to the base 12 to assure that the strut 14 does not easily separate from the base 12. A handle may be attached to a portion of each support strut 14 to facilitate lifting and lowering the struts 14 for assembly or disassembly of the collapsible shipping container 10.

FIG. 5D illustrates an example of a support structure 136 that rotatably couples to the strut 14 using a ball and socket joint. In this example, the support structure 136 includes a ball 137 and socket joint 138 where the ball 137 may freely rotate within the joint 138, but remains coupled to the socket 138. The socket 138 may be a semi-circular sphere sized to receive and couple to the ball 137 disposed at the end of the strut 14. A socket support member 139 may include a bracket or bar that securely attaches the socket joint 138 to the corner impression 28 of the base 12. Such a ball and socket mechanism allows the support strut 14 to rotate between the upright position and the collapsed position without detaching the strut 14 from the support structure 136 and without requiring vertical movement of the strut 14 when collapsing or expanding the shipping container 10.

In other examples, the strut 14 may be secured to a locking assembly by permanent fasteners. For example, the struts 14 of FIGS. 3B-3E may attach to the top side 36, 44 of the base 32, 40 at a location adjacent to the corner impressions 28. The strut 14 may be reinforced by one or more metal brackets so that the weight bearing on the strut 14 is distributed away from the edge of the base 32, 40 and towards the center of the base 32, 40.

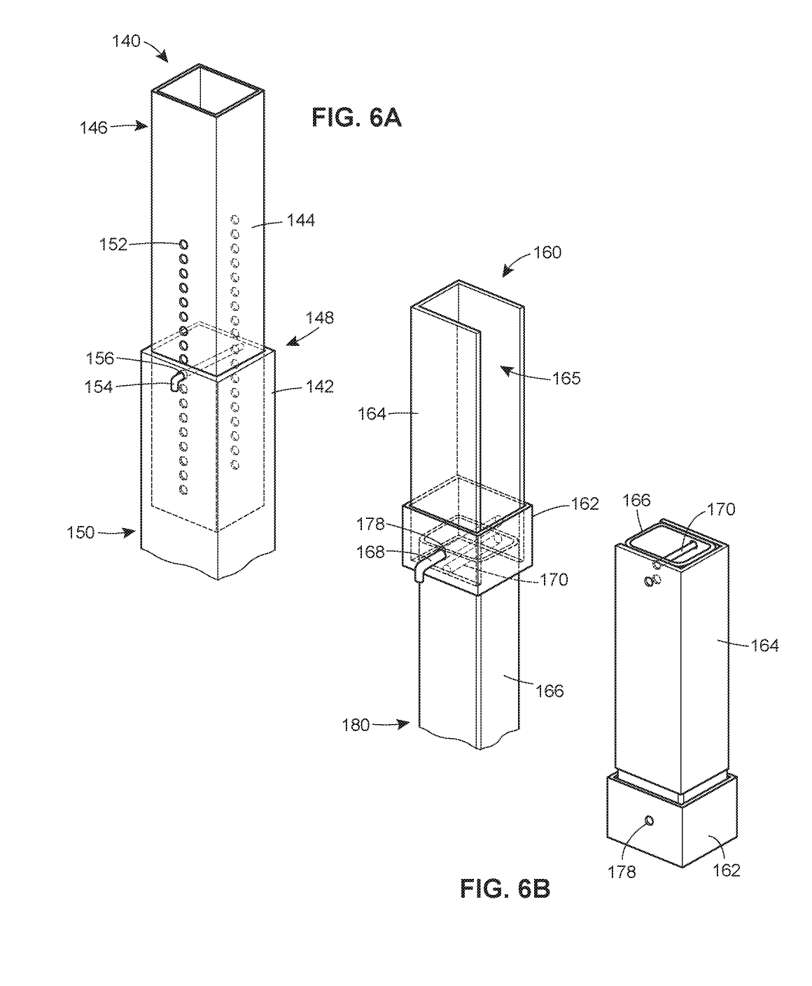

The struts 14 may be of a fixed length or may be adjustable in some manner to accommodate the size of the product being shipped. For example, FIGS. 6A and 6B illustrate two different adjustable support struts 140, 160 that are configured (for example, as described above) to rotatably attach to the locking assembly 102 and the base 12. The length of the struts 140, 160 may be adjusted to lengthen or shorten the strut to thereby configure the height of the shipping container 10 in a manner that better fits particular products being shipped. The support strut 140 illustrated in FIG. 6A is a telescoping strut that includes two nested hollow square members including a sheath 142 and a post 144 that are slidably coupled. The strut 140 of FIG. 6A expands in a telescoping manner when the post 144 slides within a cavity formed by the sheath 142. A top portion 146 of the post 144 is adapted to attach to or to come into contact with the top 16 of the shipping container 10 when fully assembled. The sheath 142 includes a top portion 148 and a bottom portion 150, wherein the bottom portion 150 attaches to the base 12 via a support structure (not shown in FIG. 6A). A plurality of holes 152, also referred to a plurality of connection sites, formed along a length of two parallel sides of the post 144 corresponds to the adjustable heights of the strut 140. To adjust the height, an operator may slide the post 144 vertically within the sheath 142 to a desired height and then may lock the strut 140 at the desired height by sliding an L-shaped pin 154 through a hole 156 of the sheath 142 and a corresponding hole 152 of the post 144. The pin 154 slides through the sheath 142 and the post 144 to lock the support strut 140 in place. To readjust the support strut 140, the pin 154 may be removed and the post 144 may slide down (or up) within the cavity of the sheath 142. Alternatively, the locking pin 154 may pass through the post 144 and rest on the top portion 148 of the sheath 142. While not shown, the locking pin 154 may be attached via a cord to some portion of the shipping container, such as the sheath 142 for example, to assure that the pin 154 does not become lost.

FIG. 6B illustrates another adjustable support strut 160 that is foldable in operation to allow the strut 160 to be expanded or contracted in length. The adjustable strut 160 includes a collar 162, a sheath 164, a shaft 166, a locking pin 168, and a rotating pin 170. The sheath 164, which may be a U-shaped bar, slides vertically relative to the shaft 166, which fits within the sheath 164. Moreover, the collar 162 is slidably disposed over the sheath 164. The rotating pin 170 is fixed to an inner wall of the sheath 164 on two sides of the sheath 164 and traverses though holes 176 in post 166. During operation, the rotating pin 170 enables the sheath 164 to rotate downwardly (from the position illustrated on the left in FIG. 6B) to wrap around the shaft 166 as illustrated on the right in FIG. 6B. To allow such rotation, the collar 162 may be slid down the shaft 166 to a point below the point at which the bottom of the sheath 164 slides over the shaft 166. Moreover, when in the expanded position illustrated on the left in FIG. 6B, the collar 162 may be slid up to have at least a portion thereof disposed over the lower end of the sheath 164 (with respect to the position of the sheath 164 illustrated in FIG. 6A) while the locking pin 170 may be inserted into the hole 178 in the collar 162 and through a set of holes 178 in the sheath 164 and via corresponding holes in the shaft 166 if necessary (not shown) to lock the collar 162 in place with respect to the sheath 164 and the shaft 166. The collar 162 thereafter prevents the sheath 164 from rotating with respect to the shaft 166 and so holds the strut 160 in the expanded or lengthened position.

The foldable strut 160 of FIG. 6B may fold down to a height that is almost half of the height of the expanded strut 160. The foldable strut 160 of FIG. 6B thus enables the shipping container 10 to be configured to be one of two heights when in the shipping or in-use configuration, and requires less room when stored in a storage channel 26 as the strut 160 can be placed into the storage channel 26 when in the folded position. In this manner, two foldable struts 160 may be stored in one channel 26, for instance, without overlapping. The adjustable struts 140, 160 of FIGS. 6A and 6B are merely illustrative of struts capable of height adjustment, and do not limit the claimed subject matter. Struts may be adjusted by other means, such as hinges, telescopic features, and snaps.

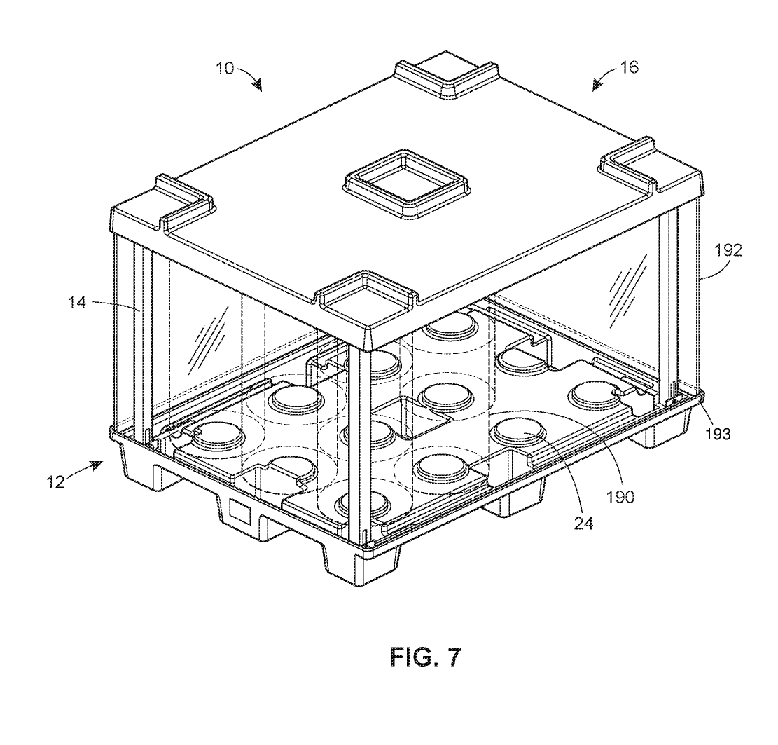

FIG. 7 illustrates an example of a customized shipping container 10 in the upright position and ready for shipment with a product stored thereon. The illustrated example partially displays a plurality of rolls of fabric or other material 190 stacked in columns and centered on the stability elements 24 of the base 12. The struts 14 are customized so that the height of the shipping container 10 corresponds with the height of the product 190. In this case, the top 16 and the base 12 hold the product 190 securely in place at first and second ends of the product 190. A final protective feature 192, such as flexible wrap, may be applied to the shipping container 10 with the product disposed therein by wrapping plastic wrap around the struts 14 for added protection and support. Flexible wrap 192 protects the product 190 from weather, dust, and debris. Additionally, the flexible wrap 192 may be a variety of colors, including transparent so the product is visible or opaque so the product is hidden. Colored wrap may be used for color-coding specific products being shipped. A sleeve (not illustrated) surrounding the product may be provided to add additional protection to the product being shipped. For example, a sleeve may be a corrugated box having four walls where the walls may have a thickness of approximately one to two inches or more. The sleeve may be made of cardboard, plastic, or other suitable material. The sleeve sits on the base 12 and abuts against a lip 193, which is disposed along the perimeter of the base 12. The lip 193 accommodates a sleeve having two inch thick walls. The lip 193 provides a barrier so that the sleeve remains on the base 12 during shipment.

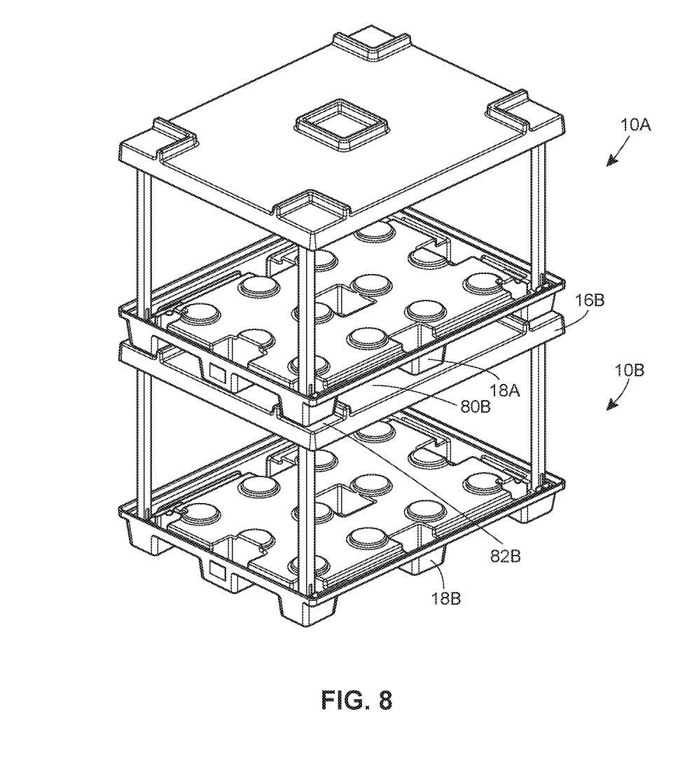

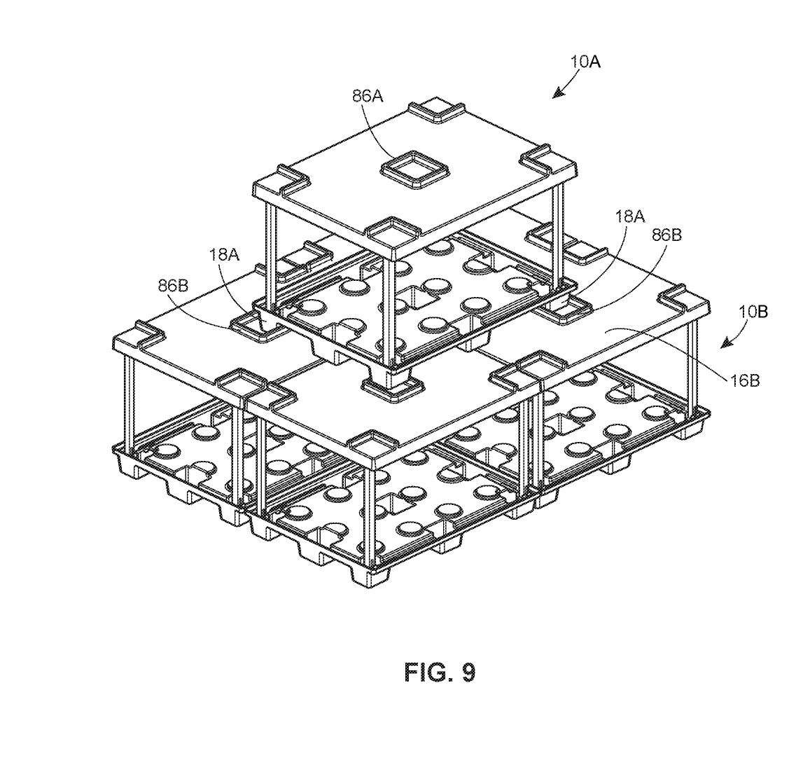

FIGS. 8 and 9 illustrate a manner in which multiple shipping containers 10 may be shipped or stored in various stacked configurations. In FIG. 8, a top shipping container 10A of FIG. 7 is stacked directly on top of an identical bottom shipping container 10B. The feet 18A of the top shipping container 10A fit securely within the stackable elements 82B located in the corners on the top surface 80B of the top 16B of the bottom shipping container 10B. FIG. 9 illustrates how a plurality of shipping containers 10 may be stacked in an off-set arrangement so that a top shipping container 10A spans four bottom shipping containers 10B. In the off-set position, the corner feet 18A of the top shipping container 10 interact with the center stackable elements 86B of the four bottom shipping containers 10B. An example of a different shipping container assembly may include a base 12, struts 14, and a second base 12 that covers the struts but also functions as a top.

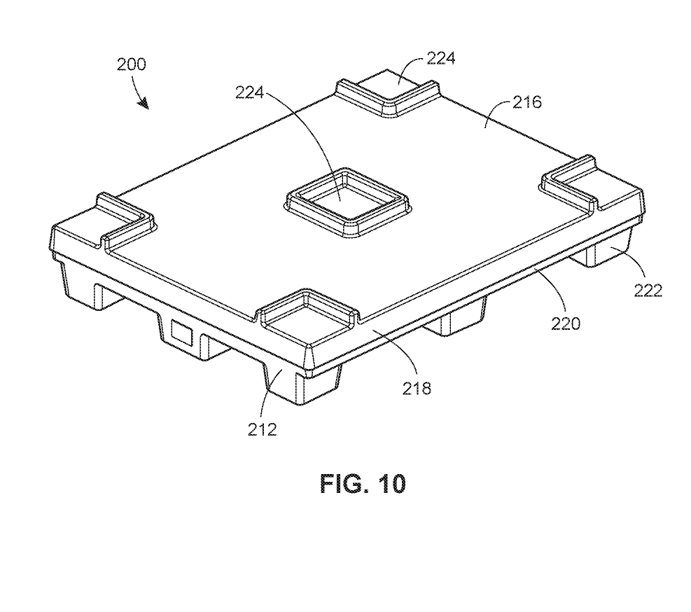

The space-saving features of the shipping container 10, such as the stackable elements 82 of the top 16 and the hollow feet 18 of the base 12, reduce the shipping costs for returning shipping containers 10. Just as two expanded shipping containers 10 are capable of stacking, a collapsed shipping container 200 of FIG. 10 is also capable of being stacked on top of another collapsed shipping container 200. The illustrated shipping container 200 includes a top 216 having a wider outer perimeter than a base 212 so that a top edge 218, also referred to as a lip, of the top 216 may engage with an outer edge 220 of the base 212 by overlapping the outer edge 220 so that the top 216 retains the base 212 during shipment. The top 216 may engage the base 212 by other means, such as a strap, a buckle, snap-fit, or other suitable means. The stackable collapsed shipping containers 200 save shipping costs because they occupy much less space than a shipping container 10 in the upright or expanded position. Collapsed shipping containers 200 may be stacked on top of one another for shipping, such that a plurality of feet 222 of the base 212 mate with a plurality of stackable elements 224 formed on the top 216.

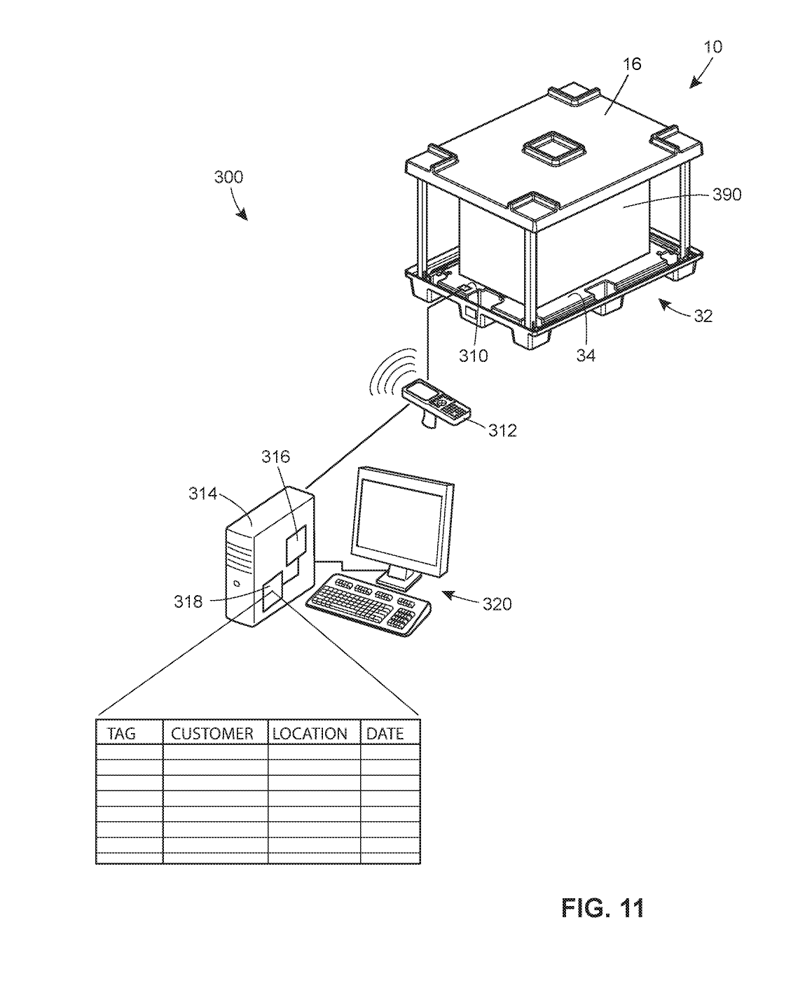

One of the many advantages that the shipping containers described herein have over existing packaging containers, such as wooden pallets, is that the shipping container 10 may be tracked to ensure recovery and reuse. A shipping container tracking system 300 illustrated in FIG. 11 allows a shipper to track shipping containers 10 in inventory and shipping containers 10 shipped to customers so that the shipper can either (1) retrieve the shipping containers 10 from the customer and reuse the shipping containers 10, or (2) recover the costs of a lost or unreturned shipping container 10. The shipping container tracking system 300 will be explained using a representative scenario of a manufacturer shipping a product to a customer, Company XYZ.

In this example, Company XYZ orders one or more replacement valves from the manufacturer. To ship the valve, the manufacturer uses a customized shipping container 10 such as that illustrated in FIG. 3B, having a base 32 and stability element 34. The shipping container 10 used to ship the valve may have been used many times before to ship valves to customers. The manufacturer can keep track of the inventory of shipping containers 10 by using radio-frequency identification (RFID) technology. To effect such a tracking system, each shipping container 10 includes an RFID tag 310 attached thereto, such as to the base 32 (and/or may have another RFID tag 310 attached to the top 16). When one or more RFID tags 310 are attached to each shipping container 10, the manufacturer may scan the one or more RFID tags 310 of a particular shipping container 10 when the shipment is outgoing, and again when the shipping container 10 is returned. When the product is ready to be shipped, the manufacturer may look in the inventory for a shipping container 10 that is customized to ship the valve. The manufacturer may set up a system for protecting the manufacturer's investment by tracking each shipping container 10 individually and storing information related to the shipping container 10, such as customized features of the shipping container 10, product shipment capabilities, shipment history, destination of shipment, customer, specifics of the product being shipped, etc., in a computer system. In this example, the manufacturer finds the specific shipping container 10, scans the RFID tag(s) 310 of the shipping container 10, and stores information attached to the RFID tag 310, for example, that the shipping container 10 will ship to XYZ Company with the valve on a certain date. To ensure that the shipping container 10 is returned, the manufacturer may charge XYZ Company a deposit for receiving the shipping container 10. In another example, the manufacturer may charge XYZ Company the cost of the shipping container 10 if the customer fails to return the shipping container 10 after a certain period of time.

In FIG. 11, the shipping container 10 having the RFID tags 310 attached to the base 32 and to the top 16 is scanned by an RFID reader 312. The RFID reader 312 transmits a first scan of the RFID tag 310 to a computer 314 where the identification of the shipping container 10 is stored in a memory 316 of the computer 314 under a unique tag identifier. An operator may view the information stored in the memory and associated with the scanned container on a user interface 320 and may assign information about the individual shipping container 10 via a microprocessor 318. The user may input information in a number of information fields relating to the shipment and data assigned to the specific RFID tag 310 such as customer name, location of shipment, date of shipment, product being shipped, etc. The data entry illustration of FIG. 11 is merely illustrative, and is not intended to limit the capabilities of the RFID tracking system 300.

The system 300 of FIG. 11 may later be used to track an incoming shipping container 10 returned by the customer. The RFID tags 310 of the shipping container 10 are again scanned by the RFID reader 312, and the tag identifier of the container is transmitted to the computer 314. The tag identifier is compared with the tag identifiers of the inventory of containers stored in the memory. The operator may retrieve information stored in the memory 316 to learn where the shipping container 10 came from and when/where the shipping container 10 was last scanned into the system 300. The manufacturer can then input information regarding the arrival of the shipping container. The system may then enable the manufacturer or shipper to determine which customers have which shipping containers 10, when a customer fails to return a shipping container, etc Likewise, separate tags 310 on the base 32 and the top 16 of a shipping container 10 may be used to track bases and tops of shipping containers individually or separately, or may be used to simultaneously track a pair of a base and a top for a particular shipping container 10.

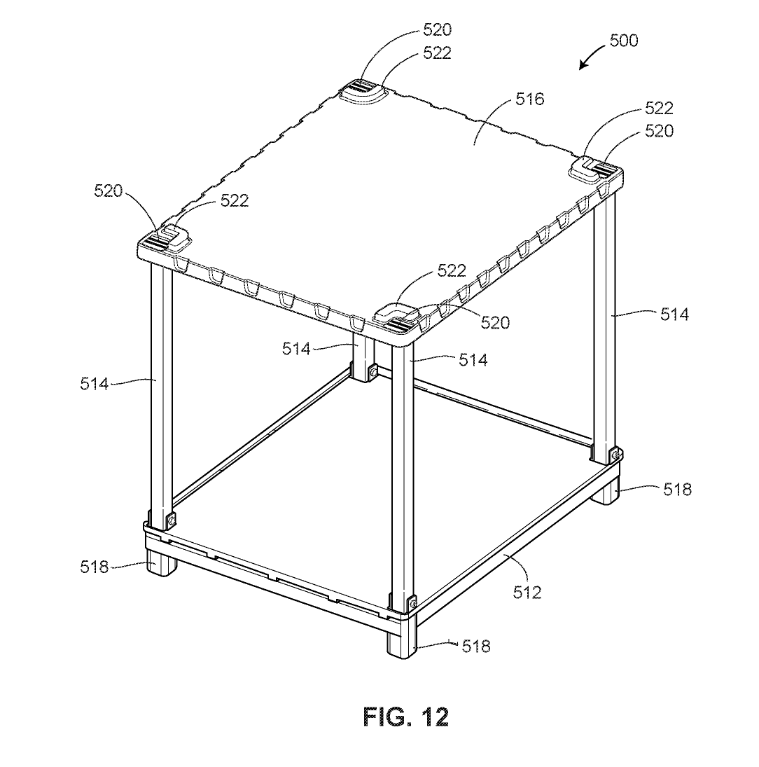

FIGS. 12-20 illustrate various aspects of a second embodiment of a collapsible shipping container 500. As illustrated in FIG. 12, which depicts the collapsible shipping container 500 disposed in an upright or in-use configuration, the collapsible shipping container 500 includes a base 512 having four support struts 514 rotatably mounted thereon, and a top or cover portion 516 disposed on top of the struts 514. In this case, the base 512 includes four legs or feet 518, one at each corner of the base 512. Moreover, the top portion 516, which may be formed of molded plastic formed around a metal or other rigid material frame, incudes support structures or support surfaces 520 and structural members 522 disposed at each of the corners thereof, in a manner that is aligned with the feet 518 of the base 512 when the top 516 is disposed on the struts 514. More particularly, the corners of the top 516 are adapted to receive the top ends of the struts 514 on an underside thereof and the surfaces 520 and structural members 522 are adapted to receive the bottom of the feet 518 of a second collapsible shipping container (not shown) when the second shipping container is disposed on top of the shipping container 500 of FIG. 12. Basically, the structural members 522 form receiving means or members for the legs or feet of a second shipping container when stacked on top of the first shipping container 500 illustrated in FIG. 12 so that the support surfaces 520 support the weight imparted by the feet of the second shipping container and the structural members 522 assist in holding the feet of the second shipping container in place during shipping.

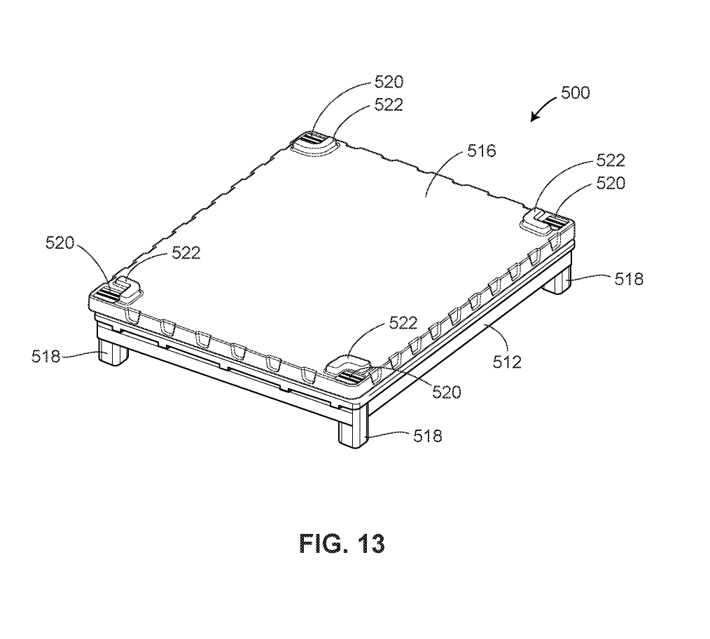

In the embodiment of FIG. 12, the base 512 has a flat upper surface, which may be formed of molded plastic and upon which, as will be described in more detail hereinafter, various inserts may be placed in order to configure the shipping container 500 for use with particular types of products. Generally speaking, the shipping container 500 operates very similarly to the shipping containers described in the previous figures such that the struts 514 are rotatably mounted on the base 512 and are thus able to be rotated down (collapsed) and stored on or above the base 512 in a collapsed position, such as that illustrated in FIG. 13.

As illustrated in FIG. 13, the collapsible shipping container 500 may be disposed in the collapsed or storage configuration with the top portion 516 disposed over the collapsed struts 514 (not visible in FIG. 13). As indicated above, the top 516 may be made of molded plastic and the support members 520 may be made of rigid material, such as metal inserts, to provide more structural support for additional shipping containers stacked thereon.

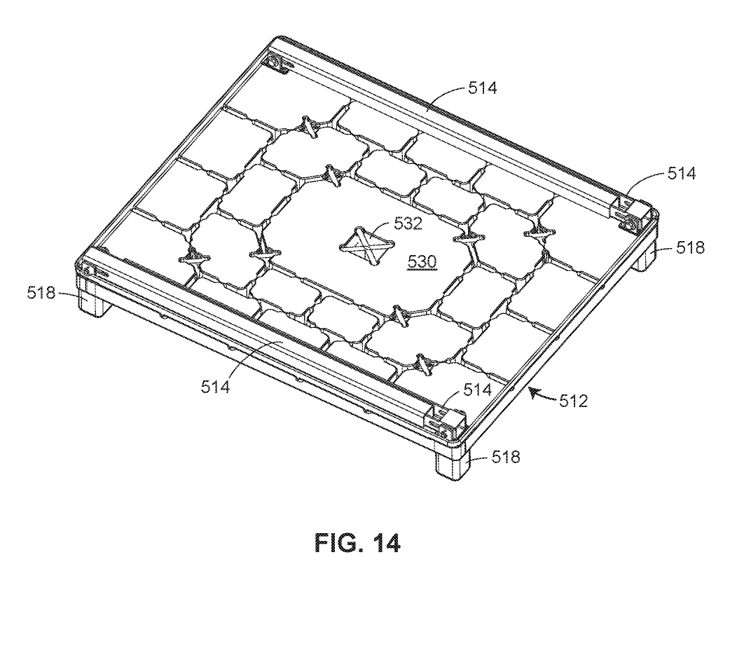

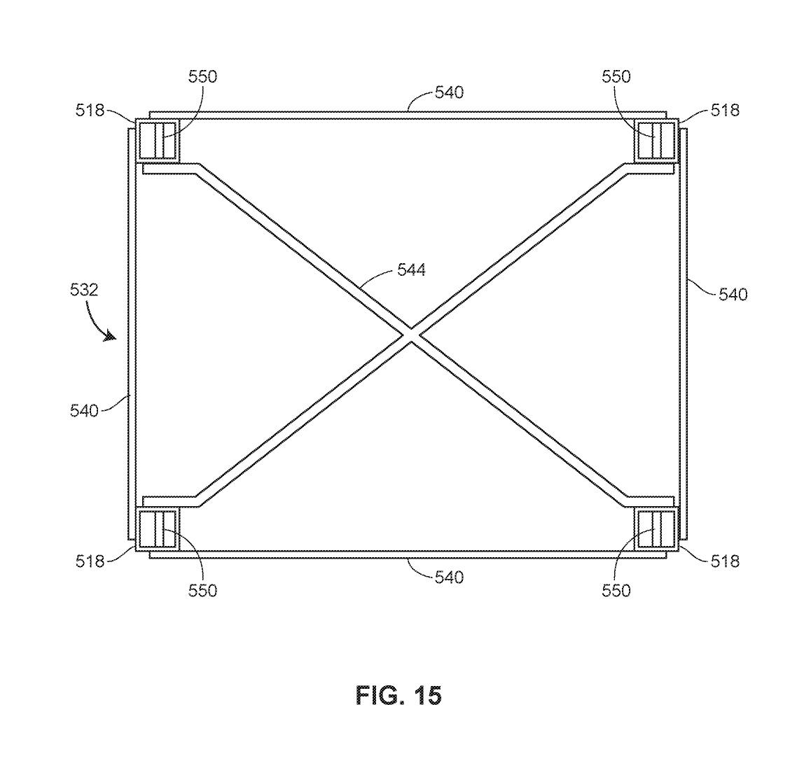

FIGS. 14 and 15 illustrate the construction of the base 512 of the shipping container 500 in more detail. In particular, the base 512 is illustrated in FIG. 14 with the struts 514 folded down into the collapsed or storage position. The struts 514 are illustrated as being made of U-shaped channel members, which interleave with one another in the collapsed or storage position. In particular, the open walls or sides of the U-shaped channels of adjacent struts 514 face each other when the struts 514 are folded down into the storage position to enable the struts 514 to interleave with one another in this position which, in turn, results in the struts 514 taking up less space in the collapsed or storage position. Moreover, the pairs of adjacent struts 514 (which fold down on the same side of the base 512) may be mounted on the feet 518 in a slightly offset position with respect to one another, so that the sides of the U-shaped channels of the adjacent struts 514 do not lie in the same plane, and thus do not hit one another when folded down into the collapsed position illustrated in FIG. 14. Alternatively, the struts 514 could be made of square (hollow) channel members, two sided or L-shaped members, flat bars, circular, square, flat, or any other type of bar stock, etc. Still further, the struts 514 could be made of any desired metal, such as steel, galvanized steel, stainless steel, aluminum, etc., or could be made of any other desired rigid and generally strong materials, such as fiberglass, fiberglass composite materials, etc. The struts 514 could be solid in construction or have holes therein to reduce weight. Of course, the struts of any of the embodiments described herein could configured or made using any of these materials and techniques.

Moreover, as illustrated in FIG. 14, the base 512 has a support member 530, which may be formed from plastic molded around an underlying support frame 532, which may be made of metal or some other rigid and structurally supportive material. As more particularly illustrated in FIG. 15, the support frame 532 of the base 512 includes four metal (or other rigid material) outer edge members 540, which may be flat metal bars for example, that attach to each of the feet 518. The feet 518 may additionally be made of metal or another rigid and structurally strong material. Moreover, an inner cross-shaped or X-shaped support member 544 connects opposing feet 518 together to provide a rigid support structure to the base 512. As will be understood, the outer support edge members 540 and the inner cross-shaped or X-shaped support structure 544 may be welded to the feet 518, may be riveted to the feet 518, or may be otherwise rigidly connected to the feet 518 in any desired manner that prevents movement of the feet 518 relative to one another. Moreover, as will be described in more detail hereinafter, each of the feet 518 includes a support pin 550 extending therethrough. The support pin 550 of each foot 518 is generally disposed towards the lower end of the foot 518 and serves to provide support for the struts 514 when the struts 514 are disposed in the upright or in-use position.

Referring back to FIG. 14, the support member 530 includes a plastic or other light weight material piece with various sections formed therein by injection molding or thermoforming, for example, formed over or around the support frame 532. The feet 518 may include at least one hole or slit that allows any dust, debris, or liquid that has been collected to drain or otherwise fall through of the at least one hole or slit in the feet 518. The support member 530 may include various ridges or channels within the injected-molded piece to provide additional structural support to the base 512 both for supporting products on top of the base 512 and for providing lateral strength to the 512 base. Of course, the configuration of the support member 530 and the support frame 532 is an exemplary nature and may be configured in any other desired manner.

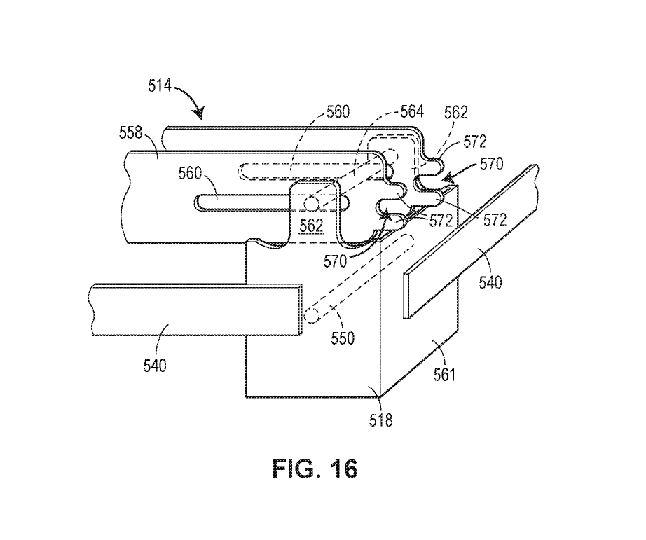

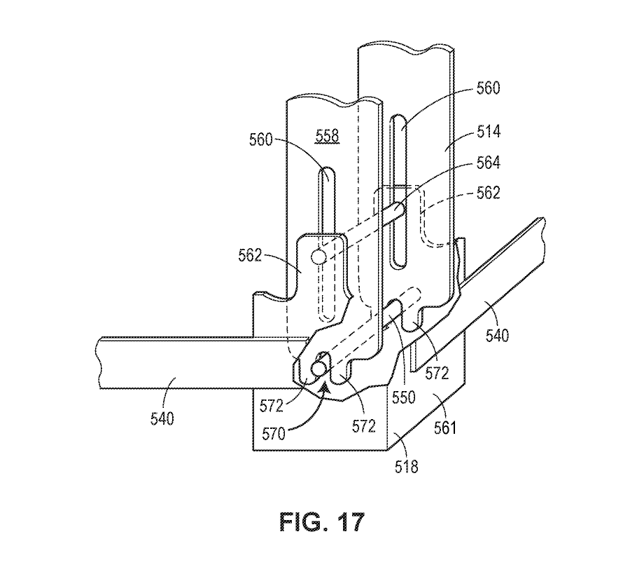

FIGS. 16 and 17 illustrate a manner in which the support struts 514 may be rotatably connected to the feet 518 both in the collapsed position (FIG. 16) and in the upright or non-collapsed position (FIG. 17). Referring to FIG. 16, the support strut 514 includes a U-shaped channel member 558 and a through slot 560 disposed within each of the two opposing sides of the U-shaped channel member 558. Moreover, each foot 518 of the base 512 is formed from a four sided square tube 561, for example, and each foot 518 includes extender tabs 562 extending from the top of the square tube 561 on two opposite sides thereof. A pivot pin 564 is disposed between the tabs 562 such that the pivot pin 564 extends through the slots 560 of the strut 514 between the two extender tabs 562 and operates to rotatably connect the strut 514 to the foot 518.

Likewise, the bottom end of the strut 514 includes a groove 570, formed therein by two protrusions 572 extending from or formed in the bottom of the two opposing side walls of the U-shaped channel member 558 of the strut 514. In particular, the protrusions 572 may be formed by cutting away one or more portions of the two opposing side walls of the U-shaped channel member 558 and the groove 570 may be formed by forming a depression or cut-away section between the protrusions 572. The groove 570 may have straight or slightly sloped walls and have a curved end nearest the through slots 560. The grooves 570 are also preferably aligned with the slots 560 and are formed at (align with) with the center of the side walls of the U-shaped channel member 558.

During the operation of changing the configuration of the shipping container 500 from a collapsed configuration to an in-use configuration, the pin 564 enables the strut 514 to slide laterally with respect to the extender tabs 562 and the feet 518 until the protrusions 572 clear the outer wall of the tube 561 of the foot 518. In particular, during movement of the strut 514 to the upright position, the strut 514 may be slid with respect to the foot 518 towards the left (in the configuration as illustrated in FIG. 16) until the pin 562 hits or comes into contact with an end of the slot 560 of the strut 514. At this point, the ends of the protrusions 572 forming the grooves 570 clear the outer wall of the foot 518, which allows the strut 514 to be rotated with respect to the foot 518 around the pivot pin 564. As illustrated in FIG. 17, when the strut 514 is rotated to be in the vertical position so that the longitudinal axis of the strut 514 aligns with the longitudinal axis of the foot 518, the strut 514 then can be slid down within the foot 514 such that the pin 564 slides within the slot 560 until the groove 570 comes into contact with the support pin 550. Of course, it will be understood that the inner cross sectional width of the tube 561 is at least slightly greater than the outer cross sectional width of the U-shaped channel member 558 to enable the U-shaped channel member 558 to be inserted into and slide within the inner space formed by the walls of the tube 561. In any event, the strut 514 may be lowered into the foot 518 until the support pin 550 of the foot 518 comes into contact with and becomes disposed within the groove 570 of the strut 514 such that the curved end of the groove 570 rests on the top of the support pin 550. When the strut 514 is in this position, the support pin 550 and the pivot pin 564 cause the strut 514 to be securely mounted on the foot 518 in an upright position, while allowing very little lateral movement of the strut 514, thereby causing strut 514 to be securely held in the upright position with very little play.

After each of the struts 514 is raised to the upright position or configuration, the top unit 516 may be placed on top of the extended struts 514 after, for example, a product to be shipped has been placed into the base support 530 of the shipping container 500. Of course, to change or configure the shipping container 500 to be in the collapsed position, the user may remove the top 516, and may pull up on the struts 514, so that the support pin 550 comes out of the grooves 570 formed on the ends of the struts 514, until the bottom ends of the strut 514 come up out of the feet 518. Thereafter, the strut 514 can be rotated at about the pivot pin 564 towards the base 510 and may slide laterally with respect to the pin 564 disposed within the slot 560 to position the strut 514 on the base 510 in a desired location. If desired, two adjacent struts 514 may be configured to interleave with one another in the collapsed position, so that the openings of the U-shaped channels 558 of the two adjunct struts 514 face one another in the collapsed position. In this case, the struts 514 may be mounted on the feet 518 slightly offset from one another, so that the side walls of U-shaped channel members 558 are not aligned with one another when in the collapsed position. In one case, it may be desirable to make the width of the U-shaped channel members 558 more narrow than the inner width of the tube 561 by more than the width of one of the side walls of the U-shaped channel member 558 to enable the struts 514 to slide from side-to-side (along the axis of the pivot pin 564) a bit when the struts 514 are rotated to their collapsed position. This amount of play will allow the struts 514 to be non-aligned when in the collapsed position.

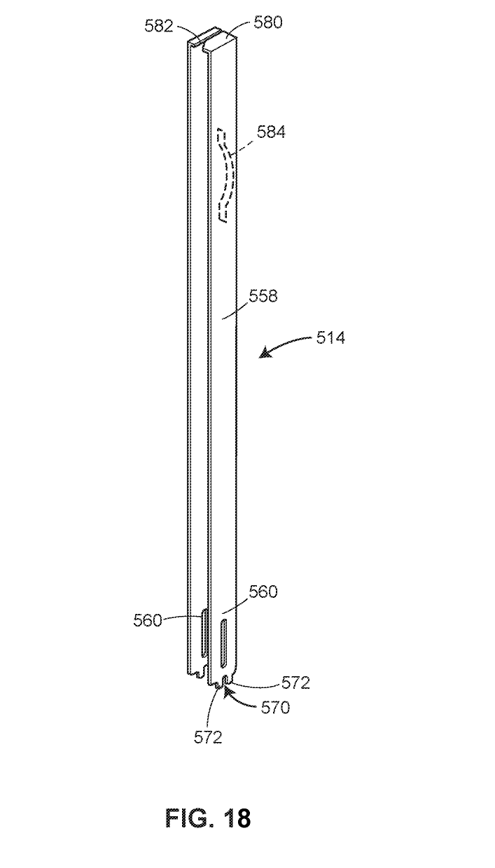

FIG. 18 illustrates a support strut 514 in more detail. In order to provide additional support to the top member or cover 516, the upper end of the support strut 514 may have a plate 580 thereon to provide more contact area between the top of the strut 514 and the underside of the cover or top 516, thereby distributing the load carried by the support strut 514 over a larger surface area of the top cover 516. To enable the support struts 514 to be interleaved in the collapsed position, however, the top plate 580 may include a groove 582 formed therein, which allows one of the walls of the adjacent or interleaving support strut 514 to be disposed through the groove 582 and thus allow two support struts 514 to lie within one another or to interleave with one another in the collapsed position. A handle 584 illustrated in dashed lines in FIG. 18 may be attached to an outer surface of the support strut 514 to lifting and lowering of the support struts 514 to transition the collapsible shipping container 500 between the in-use and storage positions, and vice versa. The handle 584 may be a fabric, plastic, metal or other suitable material. The strap 584 may be located anywhere on the strut 514 where an operator may easily grab and lift the strut 514 into place. In a preferred example, the handle 584 is located on an external surface of the U-shaped channel member 558 and positioned near the top of the strut 514. The handle 584 may be a knob, ring, loop, strap, or other handle means that facilitates assembly and disassembly of the collapsible shipping container 500.

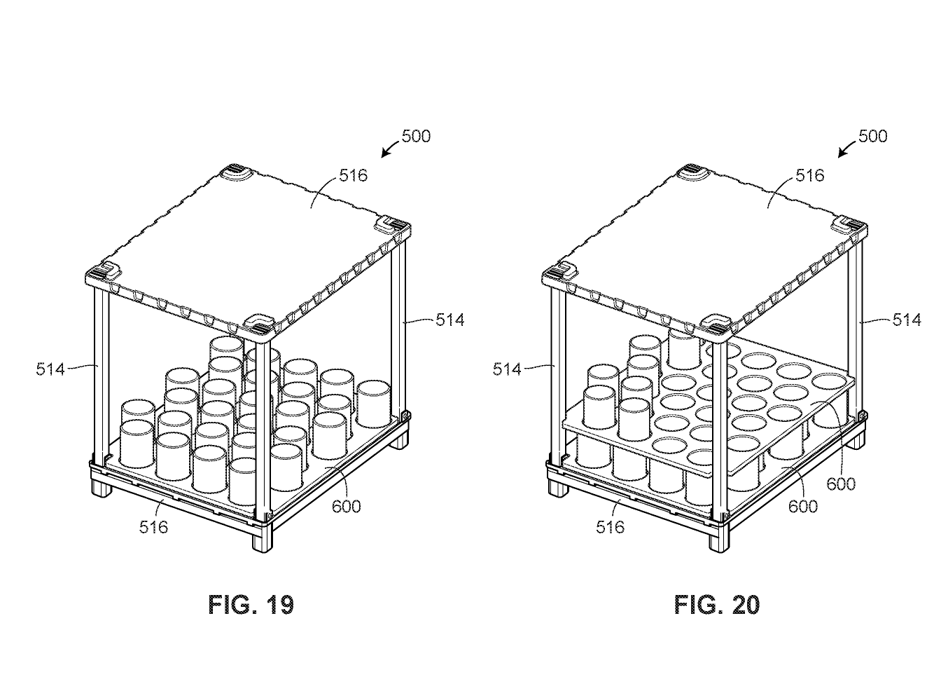

FIGS. 19 and 20 illustrate the shipping container 500 when configured used to store and ship cans of paint and, in particular, illustrate the use of one or multiple base inserts which may be used as additional base members to support the cans of paint (or other products) during shipping. In particular, as illustrated in FIG. 19, the shipping container 500 includes an insert 600 that may be formed as a relatively flat piece of molded plastic having various circular indentations or protrusions therein sized to hold the cans of paint in desired locations, such that the indentations and/or protrusions operate as product support surfaces. The insert 600 may include cutouts at the four corners thereof sized to fit within the contours of the struts 514, to enable the insert 600 to fit on the base 530 and be held within the area defined by the support struts 514 by the support struts 514 themselves. In this manner, the insert 600 will stay within the shipping container 500 even when the insert 600 is not otherwise attached to the base 512 or to the struts 514. Of course, other inserts can be manufactured with other product support surfaces to fit other products or product layouts on the shipping container 500.

Likewise, as illustrated in FIG. 20, additional inserts 600 may be used to provide additional product layers within the shipping container 500. In the illustrations of FIG. 20, two product layers of paint cans are illustrated as being disposed in the shipping container 500 using two inserts 600. However, any number of inserts 600 may be used to stack up products or layers of products within a particular shipping container 500 as desired. Moreover, the inserts 600 may have indentations on both sides thereof to conform to the bottom of a product to be shipped, as well as to the top of a product to be shipped, so as to provide more support structure for each product and product layer, as well as to hold multiple products in place within a particular shipping container.

Although the forgoing text sets forth a detailed description of numerous different embodiments, it should be understood that the scope of the patent is defined by the words of the claims set forth at the end of this paper. The detailed description is to be construed as exemplary only and does not describe every possible embodiment. Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed:

1. A pallet for shipping a product, the pallet comprising:
a base;
a plurality of support struts, each one of the support struts being movable relative to the base between an upright position and a collapsed position;
a multiplicity of connectors mounted to the base, each one of the connectors being adapted to receive a different one of the support struts to secure the different one of the support struts to the base.

2. The pallet of claim 1, further comprising a radio-frequency identification (RFID) tag attached to the base.

3. The pallet of claim 1, further comprising an insert removably attachable to the base, the insert including a stability element of a predetermined shape to receive a product.

4. The pallet of claim 1, further comprising a stability element formed in the base, wherein the stability element includes a predetermined shape that is sized to receive a product.

5. The pallet of claim 1, further comprising an insert removably attachable to the base, the insert including a moldable material adapted to form to a shape of a product.

6. The pallet of claim 1, further comprising an insert removably disposed above the base and in between the plurality of struts.

7. The pallet of claim 1, further comprising a cavity formed in the base, wherein the cavity is sized to receive at least one of the support struts when the at least one of the support struts is in the collapsed position.

8. The pallet of claim 7, wherein the base further comprises a top surface, and wherein the at least one of the support struts is disposed within the cavity and located below the top surface of the base when the at least one of the support struts is in the collapsed position.

9. The pallet of claim 1, wherein the base further comprises a top surface, a bottom surface, and a plurality of feet, wherein the plurality of feet extend from the bottom surface of the base.

10. The pallet of clam 9, wherein the plurality of feet form a plurality of impressions in the top surface of the base, and wherein each one of the connectors is disposed within a different one of the impressions.

11. The pallet of claim 9, further comprising a top having a first surface, a second surface, and a plurality of engaging members disposed on the first surface, and wherein each one of the engaging members is adapted to receive one of the support struts when the one of the support struts is in the upright position.

12. The pallet of claim 11, wherein the top includes a plurality of barrier members disposed on the second surface, each one of the barrier members being aligned with a different one of the feet when the support struts are in the upright position and engaged with the top, and wherein one of the barrier members is adapted to receive one of a plurality of feet of a second base.

13. The pallet of claim 11, wherein the top engages an outer edge of the base to retain the base when the plurality of support struts are in the collapsed position.

14. The pallet of claim 13, wherein the top includes a lip that overlaps the outer edge of the base when the top engages the base.

15. The pallet of claim 1, wherein each one of the support struts includes a first member and a second member, the first member being movable relative to the second member.

16. The pallet of claim 15, wherein the first member is slidably coupled to the second member at a connection site.

17. The pallet of claim 15, wherein the first member is rotatably coupled to the second member at a pivot point.

18. The pallet of claim 1, wherein one of the support struts is rotatably coupled to one of the connectors.

19. The pallet of claim 1, wherein the base includes a frame and a molded platform attached to the frame, and wherein the frame is rigidly connected to a plurality of feet.

20. The pallet of claim 19, wherein the frame further includes an outer member and an inner member, the outer member and inner member being rigidly connected.

21. The pallet of claim 1, wherein one of the connectors is associated with one of the support struts, the one of the connectors being coupled to the associated one of the supports struts by a connector assembly;
wherein the connector assembly includes a pin attached to the one of the connectors and an elongated slot disposed in the one of the support struts; and
wherein the one of the support struts is rotatably coupled to the one of the connectors by the pin.

22. The pallet of claim 1, wherein each one of the supports struts includes a U-shaped body having first and second parallel sides, a first end, and a second end.

23. The pallet of claim 22, wherein one of the connectors is associated with one of the support struts, the one of the connectors including a hollow tube and an aperture into which the second end of the associated one of the support struts is inserted; and
wherein the hollow tube has a top edge surrounding the aperture.

24. The pallet of claim 23, wherein the first end of the one of the support struts includes a notch adapted to receive a different first end of a second one of the support struts in the collapsed position.

25. The pallet of claim 23, wherein the one of the support struts includes a first elongated slot formed in the first parallel side and a second elongated slot formed in the second parallel side.

26. The pallet of claim 25, wherein the one of the connectors is coupled to the associated one of the support struts by a connector assembly, the connector assembly including a pivoting pin, a support pin, and first and second parallel tabs;
wherein the first and second parallel tabs extend vertically from the top edge of the hollow tube; and
wherein the pivoting pin is disposed between the first and second parallel tabs and extends through the first and second elongated slots.

27. The pallet of claim 26, wherein each of the first and second elongated slots has a first end and a second end, and wherein the one of the support struts is laterally movable relative to the one of the connectors between a first position and a second position;
wherein when the second end of the one of the support struts is disposed within the hollow tube, the pivoting pin abuts the first end of each of the first and second elongated slots in the first position; and
wherein when the second end of the one of the support struts is disposed outside of the hollow tube, the pivoting pin abuts the second end of each of the first and second elongated slots in the second position.

28. The pallet of claim 26, wherein the one of the support struts is rotatable relative to the one of the connectors from the upright position to the collapsed position about the pivoting pin.

29. The pallet of claim 26, wherein each one of the first and second parallel sides of the second end includes a groove, a first protrusion, and a second protrusion, the groove being disposed between the first and second protrusions.

30. The pallet of claim 29, wherein the groove is aligned with the support pin and is adapted to receive the support pin when the one of the support struts is in the upright position and the second end is disposed within the hollow tube.

31. The pallet of claim 30, wherein the first protrusion of the one of the support struts abuts against the top edge of the hollow tube when the one of the support struts is in the collapsed position.

32. A method of tracking a plurality of shipping pallets using a radio-frequency identification (RFID) technology, the method comprising:
providing a plurality of pallets, wherein each pallet of the plurality of pallets includes an RFID tag, a base, and a plurality of support struts movable relative to the base between an upright position and a collapsed position;
for each pallet of the plurality of pallets and before shipping the plurality of pallets to at least one customer:
scanning the RFID tag using an RFID reader to create a tag identifier that identifies the pallet;
transmitting the tag identifier from the RFID reader to a computer;
storing the tag identifier in a memory of the computer; and
inputting information into a plurality of information fields associated with the tag identifier;
shipping the pallets to at least one shipping destination wherein the at least one shipping destination is associated with one customer;
receiving at least one of the plurality of pallets from the at least one customer; for the at least one pallet:
scanning the RFID tag using the RFID reader to identify the pallet by the tag identifier;
transmitting the tag identifier from the RFID reader to the computer;
comparing the tag identifier with a plurality of tag identifiers stored in the memory;
displaying the information of the plurality of information fields associated with the tag identifier on a user interface; and
updating the information of the plurality of information fields associated with the tag identifier to indicate the at least one pallet has been received.

33. The method of claim 32, wherein inputting information into a plurality of information fields includes inputting information to at least one of a shipping destination field and a customer identification field.

34. The method of claim 33, wherein updating the information of the plurality of information fields includes changing information in the at least one of the shipping destination field and customer identification field.

35. The method of claim 32, wherein updating the information of the plurality of information fields includes adding a new information field to store information associated with a product being shipped.

36. The method of claim 32, further including displaying a message on the user interface after receiving the pallet from the shipping destination, and receiving instructions to refund the customer associated with the shipping destination a deposit.

37. The method of claim 32, further comprising displaying a message on the user interface after shipping the pallet to the shipping destination, and receiving instructions to charge the customer associated with the shipping destination a deposit.
